(19) United States
(12) Patent Application Publication
(10) Pub. No.: US 2026/0275981 A1
(43) Pub. Date: Sep. 17, 2026

(54) ADAPTABLE SUCKER ROD PUMP CONTROLLER AND SYSTEM SUITABLE FOR USE WITH VARIOUS WELL TOPOLOGIES

(71) Applicant: Ravdos Holdings Inc., Missouri City, TX (US)

(72) Inventor: Thomas Matthew Mills, Katy, TX (US)

(73) Assignee: Ravdos Holdings Inc., Missouri City, TX (US)

(21) Appl. No.: 19/557,602

(22) Filed: Mar. 5, 2026

Related U.S. Application Data
(60) Provisional application No. 63/767,436, filed on Mar. 5, 2025.

(51) Int. Cl. F04B 49/06; F04B 47/02

(52) U.S. Cl. CPC F04B 49/065; F04B 47/022; F04B 2201/1201; F04B 2201/121; F04B 2201/1211; F04B 2205/09

(57) ABSTRACT

An adaptable controller for use with, and a method of operating, a sucker rod pumping system that controls the operation of the system based, at least in part on the Coulomb forces imposed upon the system during use as a result of the interaction of the sucker rod assembly components and the well and on forces imposed on the system as a result of downhole turbulence resulting from the placement of rod guide elements on the sucker rod and/or when the outer diameter of a coupling is large relative to the inner diameter of the well in which the sucker rod operates.

### CROSS REFERENCE TO RELATED APPLICATIONS

This application claims priority to U.S. Provisional Patent Application No. 63/767,436, filed on Mar. 5, 2025.

### BACKGROUND OF THE INVENTION

The present disclosure generally relates to systems and methods for use in a downhole artificial lift system of the type that may be used to remove hydrocarbons from the ground.

One challenge associated with conventional artificial lift systems is that they often control the sucker rod pump based on a one-dimensional wave equation. Such equations were initially developed during a period when most wells were drilled in a generally vertical direction and where sucker rod pumps operated under conditions where the downhole elements of the sucker rod system were located or moved along a generally substantially vertical direction. More recently, wells have been drilled to intentionally include one or more non-vertical sections. Such wells are referenced, at times, as unconventional wells, horizontal wells, or deviated wells. A limitation of conventional sucker rod control systems is that the use of a sucker rod system within a deviated well results in forces being imposed upon the system during use as a result of the interaction of the sucker rod assembly components and the well components (e.g., the tubing placed within the well). Such forces include Coulomb forces and other forces that are not accounted for in conventional wave equations. The inability of conventional systems to accurately account for forces resulting from the use of a sucker rod assembly in a deviate well can result in sub-optimum pump performance, unnecessary equipment wear, and other negative effects.

Another challenge with the traditional artificial lift systems is that conventional controllers typically do not adequately or accurately account for forces imposed on the system as a result of downhole turbulence. Such downhole turbulence can result, for example, from the placement of rod guide elements on the sucker rod and/or when the outer diameter of a coupling is large relative to the inner diameter of the well in which the sucker rod operates. Such arrangements impose drag forces on the system as the sucker rod pump assembly accelerates through surrounding fluid. Conventional controllers do not account for such turbulence, but instead often utilized a form of a viscous damping factor (commonly referenced as a variable identified as “c”) to account for the drag forces imposed by surrounding fluid upon a moving sucker rod. While such viscous damping considerations may be used to model simple interactions between rods/rod guides and surrounding fluid such modeling does not accurately reflect the complex interactions between rods/rod guides and fluids and does not account for variations in rod guide construction.

The inability of conventional controllers to account for such forces is amplified in situations where a sucker rod pump is used in a deviated well, as rod guides are conventionally used in such applications.

A still further challenge associated with conventional well controllers is the manner in which the downhole dynagraph card is typically displayed to users of the system. Specifically, in conventional controllers, the downhole card is typically displayed in a manner that can be visually observed by a system operator, both during operation of the system and historically for analysis. The inability of conventional controllers to adequately determine or estimate the forces imposed on the sucker rod assembly under control can result in the generation and display of dynagraph cards that do not correspond to the actual operation of the pump and that are often severely distorted. Such distorted pump cards can have negative consequences for the operation of the system because such cards are often used directly for control purposes. Moreover, such representations often give rise to confusion and alarm by those attempting to evaluate the operation of the well system based on the appearance of such cards.

It is an object of the disclosure contained herein to overcome some or all of the limitations and issues described above with respect to conventional systems.

It is to be understood that the discussion above is provided for illustrative purposes only and is not intended to and does not limit the scope or subject matter of the appended or ultimately issued claims or those of any related patent application or patent. Thus, none of the appended claims, ultimately issued claims or claims of any related application or patent are to be limited by the above discussion or construed to address, include, or exclude each or any of the above-cited features or disadvantages merely because such were mentioned herein.

### BRIEF SUMMARY OF THE INVENTION

A brief summary of the inventions indicating their nature and substance may be understood from the subject matter presented in the claims filed with this application, which are incorporated into this brief summary by reference for all purposes, and by the inventions presented in any claims that may be issued from this application, which claims also are incorporated into this brief summary by reference for all purposes.

### BRIEF DESCRIPTION OF THE DRAWINGS

The following figures form part of the present specification and are included to demonstrate further certain aspects of the present invention. The invention may be better understood by reference to one or more of these figures in combination with the detailed description of certain embodiments presented herein.

FIG. 1 illustrates one exemplary embodiment of an improved artificial lift system 100 constructed in accordance with the teachings of the present disclosure.

FIG. 2 illustrates one example of an automatic configuration process 200 that may be implemented by controller 110 for automatically determining one or more of the configuration parameters useful for implementing a diagnostic or control approach.

FIGS. 3A-3D disclose aspects of exemplary processes that may be used as, or as part of, Step 206 in FIG. 2 for the determination of “static” configuration parameter.

FIGS. 4A-4C illustrate an exemplary process 800 for estimating friction, damping, and turbulence factors for use by the controller 110 for purposes of control and diagnosis of a sucker rod pumping system in the field.

FIGS. 5A-5C reflect exemplary versions of a computed downhole pump card.

FIG. 6 illustrates exemplary downhole pump card and the areas of maximum acceleration/deceleration in such a card as will occur as those areas to areas of maximum distortion caused by rod guide turbulence.

FIGS. 7A-7C reflect exemplary versions of a computed downhole pump card.

FIGS. 8A and 8B illustrate details of an exemplary sub-procedure that may be performed by the controller 110 of FIG. 1.

FIG. 9 illustrates aspects of a real-time control process that may be implemented by a controller coupled to a pumping system that is used in a deviated well.

FIG. 10 illustrates aspects of an exemplary lump division process suitable for use for predictive purposes is.

While the inventions disclosed herein are susceptible to various modifications and alternative forms, only a few specific embodiments have been shown by way of example in the drawings and are described in more detail below. The figures and detailed descriptions of these embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts illustrated and taught by the specific embodiments.

### DETAILED DESCRIPTION

The Figures described above, and the written description of specific structures and functions below, are not presented to limit the scope of what has been invented or the scope of the appended claims. Rather, the Figures and written description are provided to teach any person skilled in this art to make and use the inventions for which patent protection is sought.

A person of skill in this art having benefit of this disclosure will understand that the inventions are disclosed and taught herein by reference to specific embodiments, and that these specific embodiments are susceptible to numerous and various modifications and alternative forms without departing from the inventions we possess. For example, and not limitation, a person of skill in this art having benefit of this disclosure will understand that Figures and/or embodiments that use one or more common structures or elements, such as a structure or an element identified by a common reference number, are linked together for all purposes of supporting and enabling our inventions, and that such individual Figures or embodiments are not disparate disclosures. A person of skill in this art having benefit of this disclosure immediately will recognize and understand the various other embodiments of our inventions having one or more of the structures or elements illustrated and/or described in the various linked embodiments. In other words, not all possible embodiments of our inventions are described or illustrated in this application, and one or more of the claims to our inventions may not be directed to a specific, disclosed example. Nonetheless, a person of skill in this art having benefit of this disclosure will understand that the claims are fully supported by the entirety of this disclosure.

Those persons skilled in this art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location and from time to time. While a developer's efforts might be complex and time-consuming in an absolute sense, such efforts would be, nevertheless, a routine undertaking for those of skill in this art having benefit of this disclosure.

Further, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the scope of what is claimed.

Reference throughout this disclosure to “one embodiment,” “an embodiment,” “an example” or similar language means that a particular feature, structure, or characteristic described in connection with the embodiment is included in at least one of the many possible embodiments of the present inventions. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of one embodiment may be combined in any suitable manner in one or more other embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. Those of skill in the art having the benefit of this disclosure will understand that the inventions may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood by those of skill in the art that each block of the schematic flowchart diagrams and/or schematic block diagrams, and combinations of blocks in the schematic flowchart diagrams and/or schematic block diagrams, may be implemented by computer program instructions. Such computer program instructions may be provided to a processor of a general-purpose computer, special purpose computer, or other programmable data processing apparatus to create a machine or device, such that the instructions, which execute via the processor of the computer or other programmable data processing apparatus, structurally configured to implement the functions/acts specified in the schematic flowchart diagrams and/or schematic block diagrams block or blocks. These computer program instructions also may be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks. The computer program instructions also may be loaded onto a computer, other programmable data processing apparatus, or other devices to cause a series of operational steps to be performed on the computer, other programmable apparatus or other devices to produce a computer implemented process such that the instructions that execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and/or operation of possible apparatuses, systems, methods, and computer program products according to various embodiments of the present inventions. In this regard, each block in the schematic flowchart diagrams and/or schematic block diagrams may represent a module, segment, or portion of code, which comprises one or more executable instructions for implementing the specified logical function(s).

It also should be noted that, in some possible embodiments, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they do not limit the scope of the corresponding embodiments. Indeed, some arrows or other connectors may be used to indicate only the logical flow of the depicted embodiment. For example, but not limitation, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, may be implemented by special purpose hardware-based systems that perform the specified functions or acts, or combinations of special purpose hardware and computer instructions.

The description of elements in each Figure may refer to elements of proceeding Figures. Like numbers refer to like elements in all figures, including alternate embodiments of like elements. In some possible embodiments, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

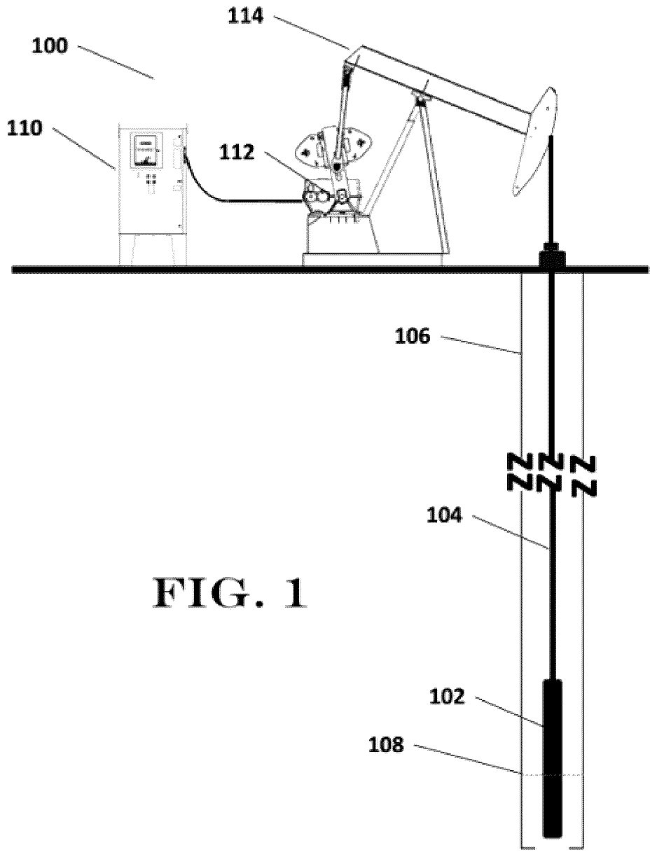

Turning now to several descriptions, with reference to Figures, of particular embodiments incorporating one or more aspects of the disclosed inventions, FIG. 1 illustrates one exemplary embodiment of an improved artificial lift system 100 constructed in accordance with the teachings of the present disclosure.

The illustrated system includes a sucker rod pump 102, that is connected to a sucker rod 104. The sucker rod 102 may be positioned within a tubing string (not illustrated) that is configured to be in fluid communication with a reservoir. The pump 102 and sucker rod 104 are positioned within a space that, in the illustrated example, is defined by the open area within a casing string 106 positioned within a subsurface wellbore.

In the illustrated example, pump 102 is positioned such that it may be stroked downwards and upwards within the well which, in the example of FIG. 1, corresponds to an interior space defined by the casing string. In the illustrated example, during such strokes, the pump 102 moves within a body of fluid having a fluid upper level 108. The fluid may take many forms and can be a fluid formed of a mixture of various hydrocarbons, water and/or any other fluid. The pump 102 may, during a single downwards and upwards stroke be fully or partially filled with the fluid during the entirety of the stroke. It will be appreciated that the illustration in FIG. 1 is at a high level and is provided for discussion purposes. As those of ordinary skill in the art will appreciated, in most constructed wells after the casing is positioned within the well, tubing will be run inside the casing. In such wells, the pump may be attached to the tubing and the sucker rods may be attached to the pump. In such (or other wells) the pump may be positioned entirely within the tubing.

In the illustrated example, as the pump 102 strokes downwards within the fluid, a cavity within the pump will be filled with fluid. As the pump 102 strokes upward fluid within the pump is released into cavity and pumped upward and out of the wellbore.

In one exemplary embodiment, the exemplary system 100 includes an electronic control system 110 that includes a drive system for activating a motor 112 driving the crank of a beam pumping assembly 114.

In one embodiment the motor 112 is a variable speed motor and the drive system is a variable speed drive. In such an embodiment, the variable speed drive system within the control system 110 may be configured to excite the variable speed motor 112 in such a manner that the rotational speed of the motor 112, and thus, the pumping speed of the beam pumping assembly 114 is varied.

Alternate embodiments, however, are envisioned wherein the motor 112 and controller 110 are such that the motor does not operate over a range of continuously variable speeds, but rather operates at one of several fixed speed settings. Still alternate forms of motors (and suitably matched variable speed drives) are envisioned wherein the motor 112 takes the form of a standard induction motor, a squirrel cage induction motor, a permanent magnet motor, a permanent magnet DC motor, a switched reluctance motors, or any other suitable motor. Further various forms of variable speed drives can be used with the appropriate drive selected based on the motor to be used with the drive. The variable speed drive can, with respect to the rotating speed of the motor, be operated either as an open loop drive or a closed loop drive.

Still further alternate embodiments are envisioned in which the motor is a single speed motor (or a motor with a set of defined operating speeds). The forms of the drive and the motor are not critical to the present disclosure.

The electronic controller 110 may take the form of a programmable processer operating off of stored instructions which cause the processor to perform the steps, operations and functions described herein. The processor in controller may take the form of a microprocessor-based computer. The electronic controller 110 may include a Human Machine Interface (“HMI”) in the form of a local or remote screen using LCD or other technology to present the images and displays to a user, some of which are describe herein.

While the electronic controller 110 is illustrated as a single element located relatively physically near the rod pump 102 in FIG. 1, it should be understood that the controller 110 can take many forms. For example, the controller can be located remotely from the pump 102, the controller 110 can be formed from multiple discrete elements including one or more local elements located physically near the pump 102 and one or more remotely located elements that communicate with the local elements via wired and/or wireless communication channels.

In one embodiment, the electronic controller 110 may be used to diagnose and control the operation of the pumping system in response to one or more received or determined control inputs.

Such control inputs may be derived, provided by the user, and/or provided by one or more sensors. Such sensors may include a sensors for sensing or inferring polished rod motion (e.g., an inclinometer, accelerometer, motor encoder or motor revolution sensor, crank rotation encoder and/or crank revolution sensor). Such sensors may also include sensors for sensing or inferring the load at a point on the polished rod (e.g., a point corresponding to the top of the rod). Examples of such sensors include, but are not limited to load cells and/or mechanical load sensing devices. Specific examples of load cells include: horseshoe-type load cells, and strain gauges. In some embodiments such direct load measuring devices can be replaces or supplemented by additional load sensor or load inferring devices, such a controller (that may be within controller 110) that infers load based on the sensed current of motor 112 or a polished rod transducer (“PRT”) that generate load-correlated signal based on changes in the diameter of the polished rod. It will be appreciated that the above discussion is exemplary only and that other sensors or approaches for determining polished rod load and/or position may be used without departing from the teachings of this disclosure. Still further,-other sensors not directly associated with rod position and/or load (e.g., sensors for detecting or inferring pressures, temperatures, vibration) may also be used.

While the number and type of received control inputs may vary from embodiment to embodiment, in at least one embodiment of the present invention, the inputs to the controller include: time; the surface position of the rod pumping system (such that the surface position v time correspondence can be determined); and the surface load experienced by the rod pumping system (such that the surface load v time correspondence can be determined). In such embodiments, the time can be determined by having the controller configured to operate a clock (that can be synchronized at times with a known accurate time source); the surface position can be determined by known position sensing apparatus, and the surface load can be determined by a load cell attached to the pumping rod. Conventional dynamometer apparatus may be used for this purpose.

In some embodiments, in addition or as an alternative to controlling the rod pumping system the controller 110 can generate diagnostic information useful for tracking, monitoring and assessing performance aspects of the system.

In the same or other of the embodiments discussed below, the controller 110 will control the system based on downhole data associated with a downhole dynamometer card (sometimes referred to as a “downhole card” or “downhole pump card”). In such embodiments, the downhole data used to generate the downhole dynamometer card may be obtained via calculations performed by the well controller 110 on rod load and position information provided by the surface sensors as well as other information provided to the controller such as information relating to physical characteristics of the pump, the rod, the pumping assembly, and other variables that could impact the operation of the pumping system. As those of ordinary skill in the rod pumping art will appreciate, a variety of approaches are known for converting surface pump card data to downhole pump card data and any suitable conversion methodology can be used to implement concepts of the present disclosure. As those of ordinary skill in the art will appreciate, to generate the data required for generation of a suitable surface card (and a downhole pump card from such surface card) the controller 110 must both: (a) sample the rod position and rod load data at a suitable frequency and (b) ensure that the rod position data is appropriately synchronized with the road load data in time. One manner of synchronizing the rod position and rod load data is to capture the load and position data as close to the same time as possible. In accordance with another approach the load and potion synchronization capture is not necessarily time based, but us rather interrupt driven as the controller receives pulse signals from a motor (e.g., when hall-effect sensors are used for position sensing and/or motor RPM detection). It will also be appreciated that load data can be a calculated value, rather than a value obtained from a load cell. The selection of suitable detection apparatus, a suitable sampling frequency, and the synchronization of load and position data, will be within the capacity of one of ordinary skill in the art of sucker rod pumping systems having the benefit of this disclosure.

The variable speed motor 112 and the variable speed drive may take different forms. In one exemplary embodiment, the variable speed motor 112 is a variable speed induction motor and the variable speed drive 110 within the control system varies the frequency of the electrical signals applied to the motor 112 so as to vary the rotational speed of the motor 112, and thus the pumping rate of the pump 102.

As will be appreciated, given the relationship between the frequency of the electrical signals applied by the controller 110, typically referenced in terms of Hertz (Hz.) to the rotational speed of variable speed motor 112, typically referenced in terms of rotations per minute (RPMs), and the relationship between the rotational speed of the variable speed motor 112 and the pumping rate of the pump, typically referenced in terms of strokes per minute (SPM), the overall “speed” of the system can be referenced in either Hz., RPMs, or SPMs. It will be understood by those of skill in the applicable art that the selection of one or more of Hz., RPMs and/or SPM to define the operating rate of the system can be made based on preference and that the use of any of Hz., RPM, or SPM to define the operating rate of the system will be equivalent to the use of any of the other terms.

In one exemplary embodiment, a controller 110 of the present invention can control the pumping system and generate more accurate dynograph cards that have been previously available by more accurately accounting for many of the load, drag, friction and other conditions experienced by the rod pumping apparatus. Such improved control is enabled by, among other things, the disclosed system's ability to: (a) more accurately reflect the Coulomb friction forces experienced by the system than available in prior art models; (b) better determine the viscous damping forces experienced by the system; and (c) utilize a turbulence factor to account for various forces resulting from turbulence resulting from movement of the pumping system through fluids not utilized in prior art embodiments. In such embodiments, the controller 110 can implement a diagnosis and control approach based on a wave equation implemented in accordance with EQUATION 1 below:

$$\frac{{d}^{2} u ( x , t )}{{dt}^{2}} = {v}^{2} \frac{{d}^{2} u ( x , t )}{{dx}^{2}} - {c}^{′} \frac{du ( x , t )}{dt} - {C}^{′} ( x ) + g ( x ) - z \frac{{d}^{2} u ( x , t )}{{dt}^{2}} \qquad EQUATION 1$$

where:
“x” is the distance of a point on the sucker rod from a define point (which may be in feet);
“t” is time (which may be in seconds);
“u(x, t)” is the displacement of the sucker rod from a defined (e.g., equilibrium) position at time t;
“v” is the velocity of sound in the sucker rod material (e.g., steel, fiberglass) (which may be in feet/second);
“c′” is a damping coefficient (which may be in 1/second), which as described in more detail below may be automatically determined by the controller 110;
“C′(x)” represents the rod on tubing drag force, which, as described in more detail below may include both a tension-independent component of friction at a given location along the sucker rod string (e.g., a given distance from surface) and a tension-dependent friction component determined at the same general location;
“g(x)” represents a rod weight component; and
“z” is a turbulence factor.

Comparing EQUATION 1 to wave equations conventionally used for sucker rod control and diagnostic purposes (such as the wave equation found in Col. 7, lines 50-67 of U.S. Pat. No. 8,036,829 to Gibbs (hereinafter “the Prior Art Gibbs '829 Patent”), it may be noted that EQUATION 1 differs from the equation provided in the Gibbs Patent at least in that:
EQUATION 1 utilizes a damping coefficient c′ determined in accordance with one or more of the processes disclosed herein (as opposed to a damping coefficient determined in accordance with the Prior Art Gibbs '329 Patent).
EQUATION 1 utilizes a rod on tubing drag force C′(x) that, as discussed in more detail below, includes both a tension-independent component and a tension-dependent friction component automatically determined in accordance with the teachings of the present disclosure (as opposed to a drag force determined in accordance with the Prior Art Gibbs '829 Patent).
EQUATION 1 includes a component utilizing a turbulence factor z (not found in the prior art Gibbs '829 Patent) discussed in more detail below.

As an analysis of Equation 1 reveals, the exemplary controller 110 of the present disclosure utilizes various coefficients, variables, force models, and other factors to control the described system. Such coefficients, variables, and factors are referred to herein as “configuration factors.”

Such configuration factors include at least: (a) the rod on tubing drag forces, C′(x), and the parameters used within the present disclosure to model such forces (which, as described in more detail below may include both a tension-independent component of friction at a given location along the sucker rod string (e.g., a given distance from surface) and a tension-dependent friction component determined at the same general location; (b) the viscous damping factor (“c′”); and the turbulence factor (These configuration factors can be determined in variety of ways.

In some embodiments some or all of such configuration factors can be entered by a user of the system based on user determined criteria or processes (such as estimation, calculation, informed guessing, etc.). In other embodiments of the present disclosure, some or all of the configuration factors may be determined empirically for the rod string as a whole or for various segments of the rod string.

In a still further embodiment of the present disclosure, the system controller can implement procedures for automatically determining appropriate values for some or all of these configuration factors through one or more automatically initiated processes

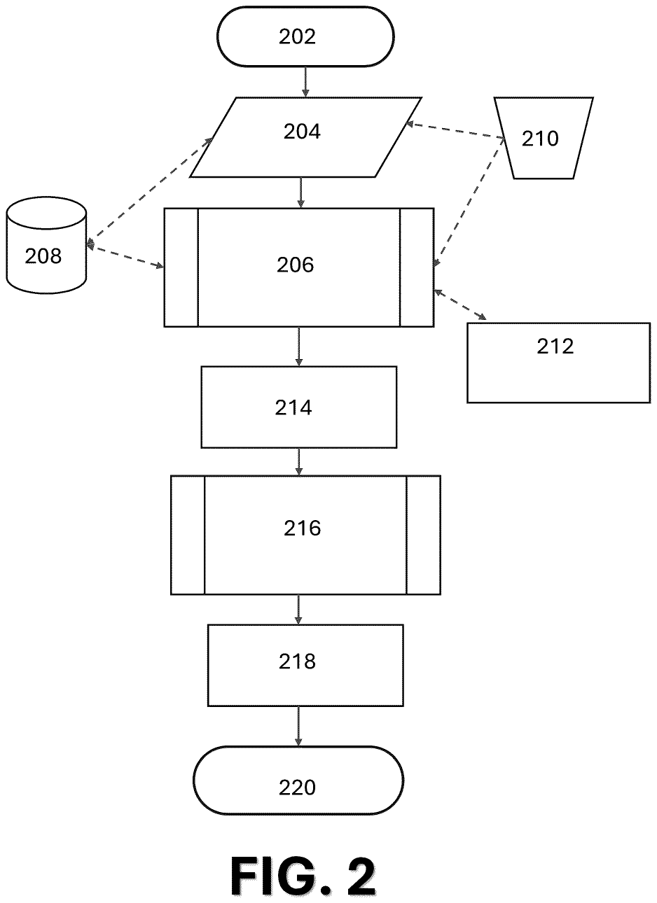

FIG. 2 illustrates one example of an automatic configuration process 200 that may be implemented by controller 110 for automatically determining one or more of the configuration parameters useful for implementing a diagnostic or control approach which in the describe example is a control corresponding to Equation 1. Those having the benefit of this disclosure will be able to adapt the automatic configuration process for utilization with other control approaches and system models.

Referring to FIG. 2 the automatic configuration process is initiated at the initial Step 202. Initiation of the automatic configuration process can occur as a result of a variety of different actions. For example, Step 202 may be initiated manually by a user, automatically by a supervisory controller, or as a result of the detection of some specific event (e.g., complete installation of a sucker rod pump system, replacement of a pump or other key equipment item, or the passage of a defined period of time since the last configuration process associated with the controller 110. For example, in one embodiment the controller 110 may be configured to automatically proceed to the initiation of Step 202 when the controller 110 is first placed in the field, and before any active control, occurs.

In the same or other embodiments, the controller 110 may be configured to initiate Step 202 as the result of one or more triggering events. An example of such a triggering event could be the detection by the controller 110 (or by another process operating under the control of software) of a change to one of the input parameters used by the controller for determining one or more configuration parameters. For example, with respect to this trigger mechanism, the software in the controller 110 may retain a set of “working” values of input parameters used for real-time control and a set of “current” values of various input parameters reflecting sensed or provided values used in the determination of one or more configuration factors. If the sensors reflect a change in a detected values, or if a human user or another software system enters values (e.g., via HMI, SCADA, keypad, electronic machine-to-machine transfer, or other means), the “current” value set is modified. Periodically, a process operating on the controller 110 can compare the “current” values to the “working” values. When a difference is noted between the “current” and “working” values for a given parameter, the process can detect a “parameter changed” event and the “working” value is updated to equal the “current” value. After the software compares all of the input parameters, if a “parameter change” event has been detected, then the controller can implement the initiation of Step 202.

Other triggering events for Step 202 are envisioned, such as the passage of a certain amount of time, the detection of an unexpected sensor value, or validation checks from a supervisory controller or user. In still further, embodiments, Step 202 may be triggered by a “major event” is detected or occurs or redetermination of such factors is deemed warranted. As used in this disclosure a major event is an event that reflects a change in either the pumping system, or the environment in which the pumping system is operating, that render one or more of the determined factors inaccurate or of questionable accuracy. Such major events might include, but are not limited to: changes in wellbore equipment; changes in the pumping equipment; meaningful changes in the production rate of the pumping system; meaningful changes in the mix of oil, water, gas output by the pumping system; changes in the downhole temperature (e.g., as a result of a cyclical steam injection process). For example, if a well is “worked over” (e.g., equipment is changed in the well) the pre-calculation process (200) described above may be performed again-using the updated well equipment configuration-producing a new set of precalculated values (112) for use by the controller for real time control purposes.

In some embodiments the occurrence of a major event may be noted by a user of the disclosed system. In such embodiments and/or in other embodiments, the controller may utilize provided inputs to detect the occurrence or likelihood of a major event. Additionally, or alternatively, the controller may be configured to redetermine one or more of the determined configuration factors on a periodic basis (e.g., every three months) or upon a determination that a particular volume of fluids has been pumped since the last determination.

Once automatic configuration process is initiated at Step 202, the controller 110 may move to Step 204 where it acquires (or confirms access to) the input parameters necessary for the pre-calculation process. This step reflects the acquisition of data to be used in the commissioning process (and/or the confirmation that the necessary data is accessible to the controller 110). Such data will include the data necessary for determination of the configuration parameters and/or for the control of the rod pumping system once the configuration parameters are determined.

Such data can include but are not limited to, a deviation survey data for the well associated with the controller which will normally contain a set of measured depth, inclination, azimuth three-tuples representing measured points along the wellbore path. Such data may also include information about various components within the sucker rod system such as the sucker rod. The information relating to the sucker rod may be provided in terms of information relating to installed rod “tapers.” As used herein, a rod “taper” refers to all or a section of one or more sucker rods, or multiple sections, or to the entirety of a continuous sucker rod) which have/has homogeneous properties for its entire length. Such rod taper information may include some or all of the following:
Length;
Diameter;
material properties (material type, modulus of elasticity, density or specific length);
type of rod guides installed on rods within the taper and the location of such guides;
viscous damping factors to use in wave equation for this taper (maybe up and down factors or maybe just a single factor for up and down);
turbulence factor to use for this taper (maybe up and down factors or maybe just a single factor for up and down);
any custom coefficient of friction value which should be applied to this taper; and/or
rod coupling type.

Additional parameters that may be obtained in Step 204 may also include fluid properties associated with the fluids expected to be displaced by the pump within the system which may include-but are not necessarily limited to:
density or fluid pressure “gradient”;
gas/liquid ratio or gas/oil ratio;
oil-water ratio or water cut;
oil API gravity;
water density or API gravity;
gas specific gravity or molecular composition;
Pressure-Volume-Temperature (PVT) properties of the oil, water, or gas; and/or
viscosities of oil, water, gas or composite mixture

Still further input parameters obtained in Step 204 may include tubing related properties (for any/all sections of tubing installed within the well) and pump-related parameters including, but not limited to:
tubing inside or nominal diameter;
tubing material type;
tubing coating type;
estimated surface tubing pressure;
estimated temperatures in the tubing;
pump mechanical dimensions (including plunger-barrel clearance);
estimated pump intake pressure;
pumping unit stroke length; and/or
pumping unit stroke period or “strokes per minute.”

Still further information that may be acquired in Step 204 includes, but is not limited to the coefficient of local friction for various rod/tubing contact type, sometimes designated as Mu. Such coefficient of friction factors can be provided in various forms and manners including, but not limited to:
the provision of Mu values on a taper by taper basis; and
the provision of Mu values as a table of Mu vs. location on the rod string (or depth).

In still further exemplary embodiments a “base Mu” can be provided for the entire rod string (or for segments of the rod string) and “modifiers”-based on rod guide type, for example—can be applied to various sections of locations (or sub-sections) on the rod string. For example, a base Mu of 0.1 can be provided and when the taper has no rod guides, the modifier is 1.0 (final Mu value=0.1*1.0) or when plastic rod guides are installed a modifier of 1.5 might be used (final Mu=0.1*1.5).

It should be appreciated that the above discussion reflects only examples of the form in which the Mu data may be provided and is not intended to exhaustively reflect of all possible ways to express local Mu.

The data acquired in Step 204 can be provided from a variety of different sources. For example, such data can be provided by a data base or data storage element 208 that is accessible by the controller 110 or that is integral with the controller. Additionally, or alternatively, such data can be provided manually by a user of the system and/or by a process 212 operating independent of the automatic configuration process 200. For example, a process operating on a computing device separate from the controller 110 could be acquiring and/or generating various data elements useful by the controller 110 for performance of the automatic configuration process.

For purposes of the following discussion it is presumed that as a result of performance of Step 204, the controller 110 will access to data reflecting various parameters of the well in which the pumping system will be used. Such parameters may be provided in the form of estimated data or data generated during the drilling of the well or a wireline survey run after casing and/or tubing has been set or place in the well (or a combination of the preceding). Such reports are at times referred to as “well surveys,” “deviation surveys,” “well reports,” (or other similar terms).

Once the required data has been acquired (or confirmed) in Step 204, the automatic configuration process can move to Step 206 where various configuration parameters may be obtained, determined, or estimated without operating the sucker rod pump to which the controller 110 is attached. (NOTE: for the following discussion reference will be made to the determination of configuration factors. This reference is intended to cover the receipt of configuration factors by the controller 110, the generation of estimated configuration factors by the controller that may later be refined or adjusted, and factors determined by the controller through performance of one of the processes described herein).

In one exemplary embodiment the configuration factors determined by the controller 110 during Step 206 will be those factors that that are essentially “static” and do not change in real time during operation of the pump can be received, determined, or estimated. Such factors include, but are not necessarily limited to the, configuration factors necessary for determination of the Coulomb friction component, C′(x), found in Equation 1. Various processes for determining such factors are discussed below.

It should be appreciated that the controller 110 need not automatically determine all configuration factors determined in Step 206. Embodiments are envisioned in which some or all of various configuration factors are provided, at the well operator's discretion, to the controller 100 (e.g., from a user 210, from a database 208, or from a separately operating process 212). Additionally or in lieu of providing specific configuration factors, the user 210 or an externally operating process 212 may supply the controller 100 in Step 206 with various estimates of one or more configuration parameters, range limits for such parameters, or other inputs that can be used by the controller 100 in Step 206.

Because the configuration parameters determined in Step 206 are, at least in part, “static” those configuration parameters need not be determined by the controller 110 during or after field installation of the controller. Moreover, because such configuration parameters are not necessarily based on information obtained through operation of the pumping system associated with controller 110, such configuration parameters can be determined prior to field installation (e.g., through a “pre-calculation” process) or at any time by a computing device other than the computing device within the controller 110. For example, to reduce the real time computing burdens imposed on the controller 110 during operation of the system (and/or to permit the use of less powerful processors within the controller 110) all or portions of the operations used to determine the state configuration parameters in Step 206 can be performed well in advance of any active, real time, control operations of the controller 110.

Additionally, or alternatively, in some exemplary embodiments, some or all of the configuration parameters determined in Step 206 can be determined by a process 212 operating on a computing device different from the controller 110. Such different computing device may be located apart from the field in which the controller 110 is located) and the results of the pre-calculation process can be provided to the controller 110. In alternate embodiments, the controller 110 can be configured to run a pre-calculation routine that generates various pre-calculated configuration factors and then stores those configuration factors at known locations either in volatile memory (in which case, they would be recalculated each time the controller 110 restarts), or they might be retained in non-volatile memory-avoiding the need to recalculate on startup-until they are replaced with new values. In this alternate embodiment, once the configuration factors are so stored, the controller 110 can then be configured to run additional process that merely access the known locations for the stored configuration factors.

Exemplary processes that can be implemented in Step 206 for determining the static configuration parameters are discussed in more detail below.

Once the controller 110 has determined the static configuration parameters in Step 206 it can then store those static configuration parameters (and, potentially one or more control solutions obtained using those parameters) in dynamic or static memory accessible to the controller in Step 214. It will be appreciated that, in some embodiments, the Step 206 includes two sets of process operations, one run with the direction specified “down” and the pump load specified as zero and the other run with the direction specified as “up” and the pump load specified as zero.

Following the determination and storage of the static configuration parameters in Step 214, the exemplary described controller can them automatically determine one or more configuration parameters based on operation of the pumping system associated with the controller 110 and/or can operate the pumping system associated with the controller 110 to generate data that can be used to validate or adjust one or more of the static configuration factors determined in Step 206. The configuration parameters that may be determined in Step 216 include the improved viscous damping factor “c′” referenced in Equation 1 (above) and/or the turbulence factor “z” referenced in Equation 1 (above). Exemplary processes that the controller 110 can follow for making such determinations are set out in more detail below. Although not specifically illustrated in FIG. 2, it will be appreciated that, as part of performing the process Step 216, the controller 110 can access or be provided with data and/or input instructions from a data storage device 208, a user 210, or a separately operating process 212.

Upon the completion of Step 216 the controller 110 should have access to all configuration parameters required for to implement the wave equation set forth above as Equation 1 and to control the operation of the pumping system based on that equation (e.g., based on dynagraph cards that may be generated using Equation 1).

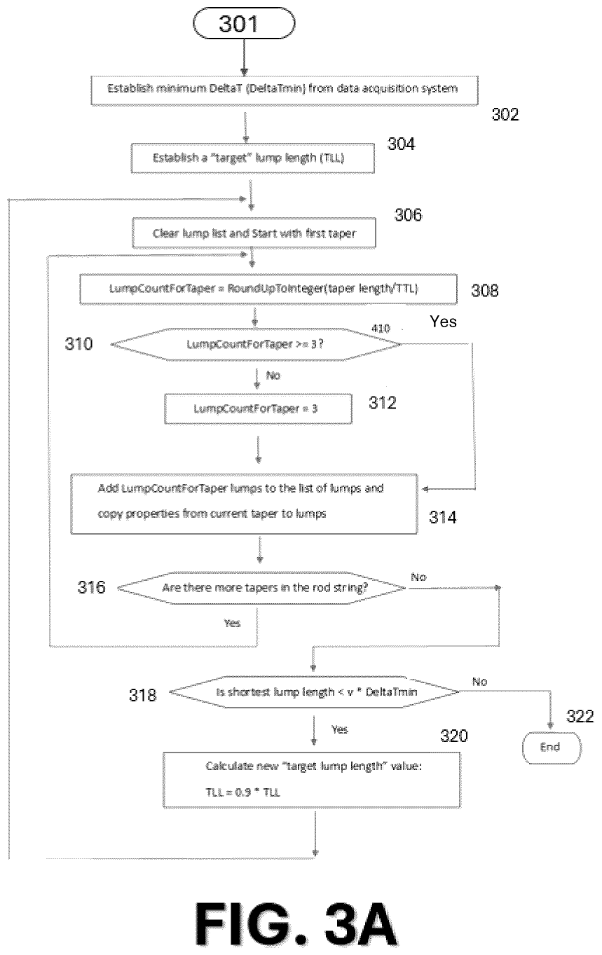

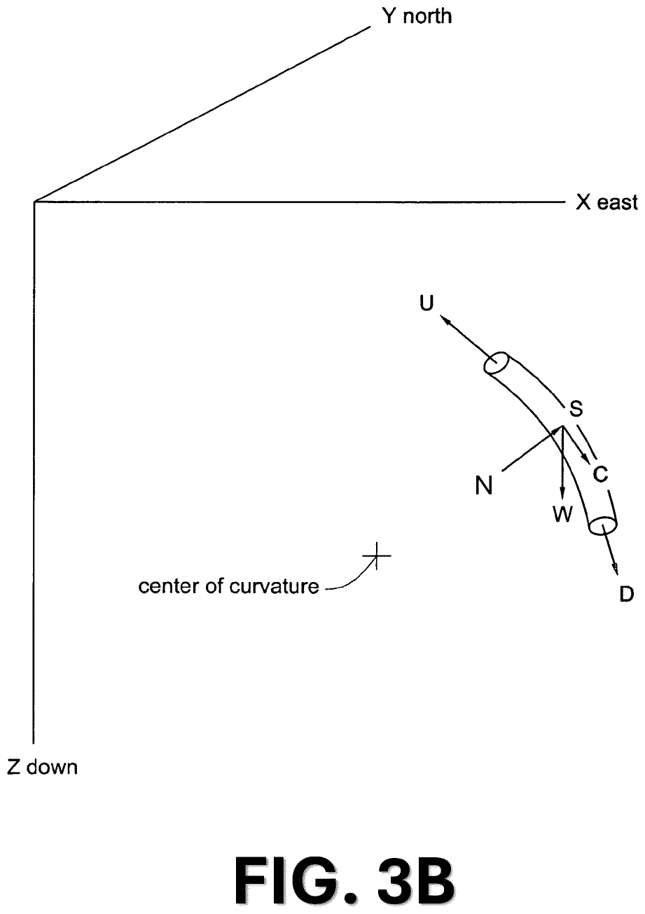

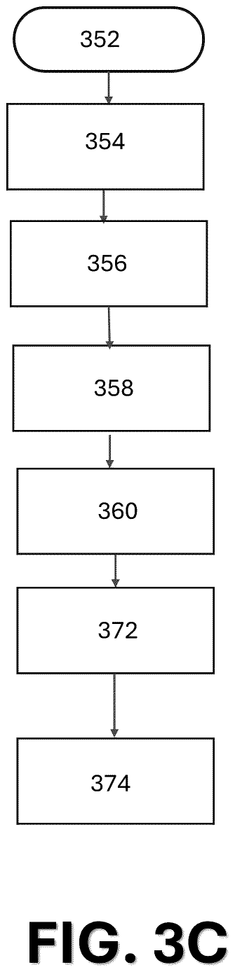

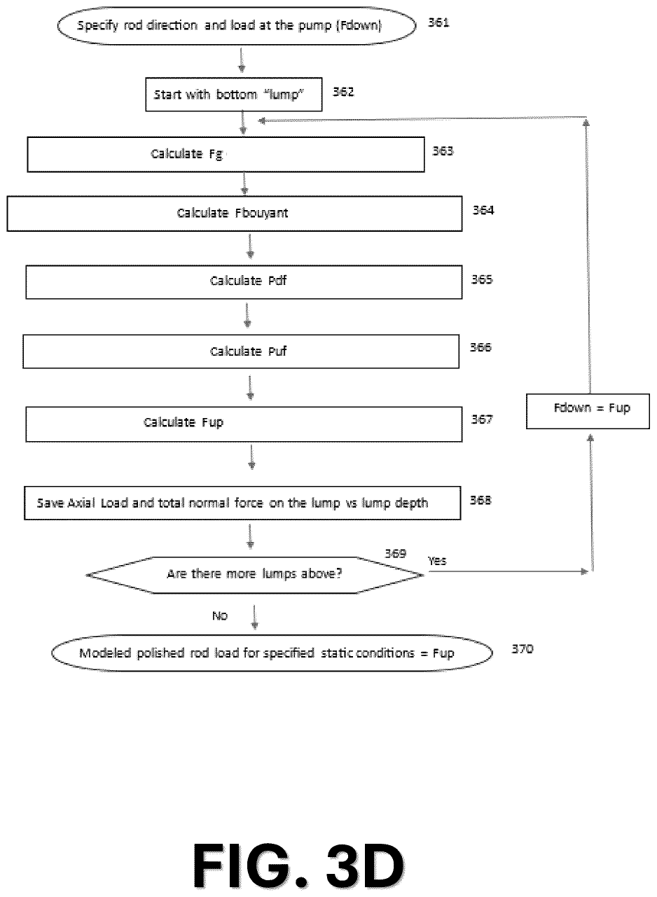

As Step 206 in the automatic configuration process 200 is a step in which one or more static configuration parameters are automatically determined (by the controller 110 or through a pre-calculation process). FIG. 3A-3D disclose aspects of exemplary processes that may be used as, or as part of Step 206 for the determination of “static” configuration parameters, useful for determination of the Coulomb friction component “C′(x)” of Equation 1.

As an overview the exemplary process of FIG. 3A-3D involves a process in which the rod string is initially divided, for purposes of analysis, into discrete segments referred to herein as “lumps.” Using one or more of the approaches discussed below, various factors associated with the Coulomb friction experienced by each lump are determined and an overall Coulomb friction model for the rod string is generated. As noted above, the process for determining Coulomb friction model utilized in certain embodiments of the present disclosure represents Coulomb friction as being partially (linearly) dependent upon local rod tension and partially independent of rod tension. This new friction model process more accurately reflects the Coulomb friction experienced by the pumping system and address a circular dependency existent in prior art friction modeling approaches.

As describe above, in one disclosed embodiment, as an initial step in determining the status configuration parameters, the controller 110 (or another computing unit participating in the completion of the step in which such parameters are determined) will divide the sucker rod string into a number of discrete lumps. A variety of different processes can be used to divide the rod string into lumps for purposes of controlling a pump system. One such exemplary process 300, suitable for use in an exemplary embodiment of the present disclosed in reflected in FIG. 3A.

Referring to FIG. 3A, the process 300 for dividing the rod string (or tapers) into lumps is initiated at initiation Step 301. Then at step 302, the controller 110 will determine or assign a minimum time differential (AT) over which the polish rod load and position information will be sensed during operation of the system. As will be appreciated the more frequent rod position/load data is sensed the lower the AT and the shorter the lump segments will need to be for appropriate system control.

In some embodiments, the AT parameter will be set within the data acquisition subsystem used by the controller 110 to collect polished rod load and position information in the field. In such an embodiment, the value of the AT parameter will be one of the data inputs received by the controller during Step 204 of process 200. Alternately, the AT parameter could be estimated by the controller based on expected operating conditions, provided by a user, or assigned by the controller 110 based on its operating configuration. In general, when considered for control or diagnostic purposes AT will be controlled by the frequency with which polished rod load and position values are sensed/measured.

Once the minimum AT has been established by the controller 110 in Step 302, the controller will proceed to Step 304 where a target lump length will be determined. The target lump length may be a value provided by the user, a factor provided in Step 204 of process 200, or an arbitrary value. In some embodiments the lump length may be determined by the controller based upon at least one or more specified requirements. One example of such a requirement is a “three lump minimum requirement” which requires that each rod taper must include at least three lumps. This requirement may be of significance in cases where relatively short (250-ft, for example) sections of “sinker bars” are installed at the bottom of a rod string.

A further example of a requirement that may be imposed in Step 304 is the “lump-taper boundary requirement.” In accordance with this requirement, each rod “taper” must be divided into an integer number of lumps. Knowing the lengths of the tapers used in the rod string, the controller may automatically determine a target lump length that would fulfill this criterial. Another way of stating this is that each taper boundary must have a corresponding lump boundary.

Yet another potential requirement that can be imposed in Step 306 is a “stability criterion requirement” requiring that the length of the lumps must satisfy the “stability criterion” for the finite element solution. When the controller 110 will be used for controlling or diagnosing a sucker rod pumping system in the field, the stability criterion can, in some embodiments, be considered as requiring that the lump length (AX) comply with Equation 2 below:

$$\begin{matrix}Δ X & <=\end{matrix} V * Δ T \qquad EQUATION 2$$

where:
ΔX is lump length [commonly expressed in feet];
V is the speed of sound in the rod material [commonly expressed in feet/sec];
ΔT is the time step used for the finite difference calculation. [commonly expressed in seconds].

In determining the target lump lengths in Step 304, it may be considered that drilling deviation surveys are often reported at 100-ft (90 meter in metric) intervals. Thus, although not essential, it may be preferred/practical in certain applications that the lump lengths be selected such that each lump contains at least one deviation survey point. In at least one embodiment, the lumps are initially defined as the segments between the deviation survey points. Lumps are then added to comply with the three lump minimum” and “lump taper boundary” requirements described above.

It should be noted that the finite difference solution method does not require that time intervals be consistent for a single stroke or that “lump” lengths be consistent along the rod string. In fact, because of the “lump-taper boundary” requirement, lump lengths usually vary with depth.

Once the target lump lengths have been determined the controller can then proceed to divide the rod string/tapers into a number of lumps, and determine the structure of each lump, beginning at Step 306 with the uppermost or top taper. For each taper, a lump count is determined by dividing the taper length by the target lump length. This quotient is rounded up to the nearest integer at Step 308. If the previous process is determined in Step 310 to result in fewer than three tapers, then the number of tapers is set to three at Step 312.

Given the lump count for the current taper determined in Step 310 (or Step 312), the lump list is then appended with the specified number of lumps in Step 314. In Step 314, each of the lumps in the taper is then assigned a length equal to the taper length divided by the lump count for the taper under division (i.e., the “LumpCountForTaper”). In the same Step 314, each of the lumps are then assigned properties (diameter, weight/density, modulus of elasticity, etc) equal to those of the current taper. In at least one embodiment, the lumps do not directly possess properties. Rather the lumps contain a reference to their associated taper and the lump properties can be derived via reference to the taper. This approach saves computer memory.

This process is repeated until a determination is made in Step 316 that all tapers have been processed.

When a determination is made in Step 316 that all tapers have been processed, a final check is made at Step 318 to ensure that the stability criterion is satisfied (in embodiments where such criterion is implemented). If the determination is made in Step 316 that the shortest lump is too long, a new (shorter) target lump size is set in Step 320 and the process begins again Step 306 by resetting the lump list and processing all tapers again. If the shortest lump length satisfies the stability criterion, then the process is complete and ends at Step 322.

Those familiar with the art will appreciate that further requirements may be imposed on the “lump” selection process, for example due to limitations of a particular finite difference approximations being employed.

Once the controller has divided the tapers forming the sucker rod string into lumps and associating properties with each lump, the controller can then determine the configuration parameters reflecting the “drag” forces caused by rod-on-tubing or rod guide—on-tubing lateral forces in the system (sometimes referred to as “Coulomb friction”) to be operated by the controller 100 by removing energy from the system at specific locations along the rod string. Various and multiple approaches can be implemented by controller 110 for determining these configuration parameter. Exemplary approaches include known Coulomb friction models (which are not described in detail here) including the approach discussed in the Prior Art Gibbs' 829 Patent.

In one exemplary embodiment, the controller implements a local Columb friction model, C′(x), partially based on “local” rod tension and partially independent of local rod tension. As used in this discussion, “local” rod tension (or Coulomb friction) refers to the rod tension (friction) experienced by the sucker rod within a particularly identifiable physical region or lump. In such exemplary embodiments, the local Columb friction force may be modeled as a force that:
(a) varies in direction depending on whether the sucker rod is moving up or down and
(b) varies proportionally in response to the sum of:
   (i) a tension-independent component of friction at a given location along the sucker rod string (e.g., a given distance from surface) and
   (ii) a tension dependent friction component determined at the same general location along the sucker rod.

For example, in one exemplary embodiment, EQUATION 3 may be used to determine local Coulomb friction forces in which: (a) a location coefficient of friction is determined for each location x (or lump) for which the local friction is determined and/or (b) the tension dependent friction component is determined based on the general modulus of elasticity of the local rod lump and the cross-sectional area of the lump for which the friction forces are being determined. In such embodiments EQUATION 3 (below) can be used to determine the local Coulomb friction forces:

$${C}^{′} ( x ) = δμ ( x ) * [ Q ( x ) + T ( x ) EA \frac{du}{dx} ] \qquad EQUATION 3$$

where:
C′(x) is the local Coulomb friction force determined in accordance with the teachings of the present disclosure;
x defines a particular location along the sucker rod string (e.g., a depth in the axial direction)

$$δ = \frac{\frac{du ( x , t )}{dt}}{\vert \frac{du ( x , t )}{dt} \vert}$$

and indicates rod direction at the time of calculation (up vs down)
μ(x) is local coefficient of friction (“Mu”) for the rod segment/lump
Q(x) reflects a tension-independent component of Coulomb friction at x at time t
T(x) reflects a tension-dependent component of Coulomb friction at x at time t
E is modulus of elasticity of the rod segment/lump
A is the cross-sectional area of the rod segment/lump
du/dx is evaluated at the local lump, in real time.

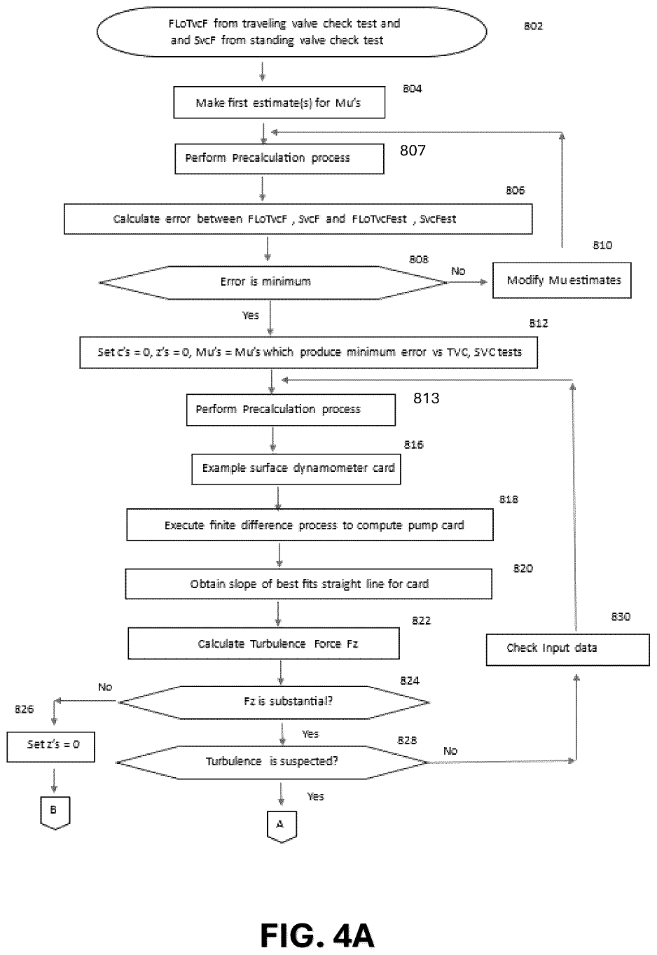

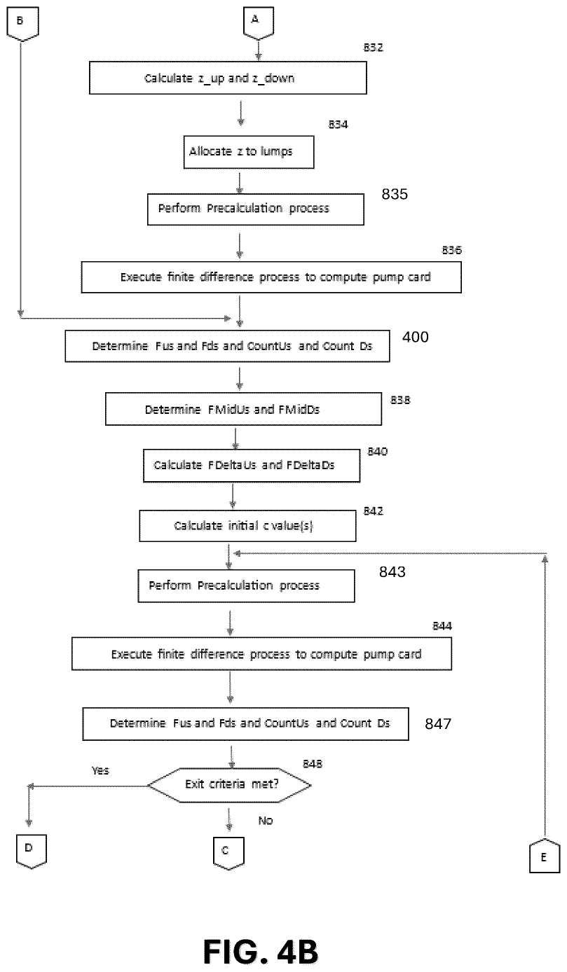

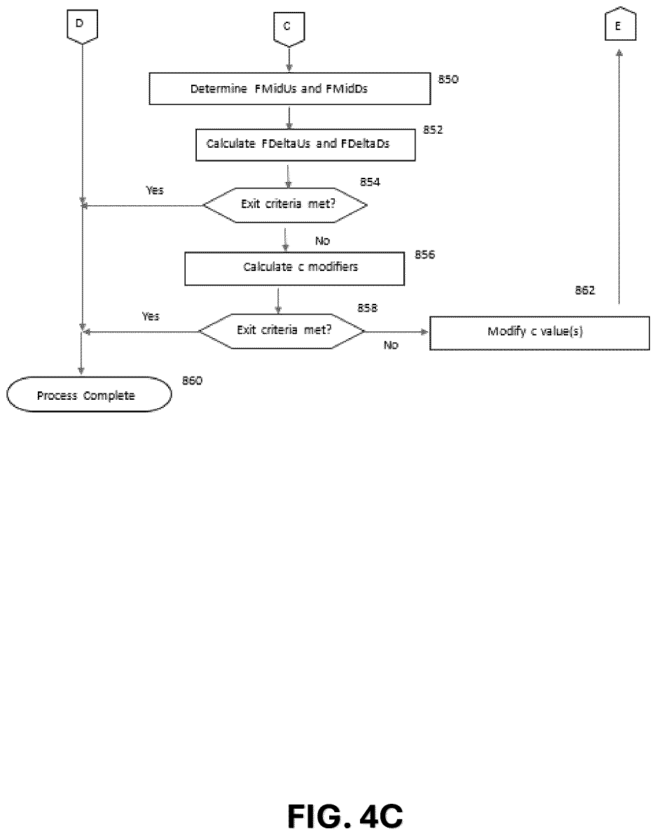

To understand the manner in which a controller 110 operating in accordance with the present disclosure may determine the static configuration parameters related to Coulomb friction, it is helpful to have a reference in which to discuss various forces and aspects of the lumps determined as described above. For purposes of establishing such a reference, FIG. 3B provides a conceptual depiction of a “lump” of a sucker rod as it may exist in a curved state. (NOTE: FIG. 3A was derived from FIG. 4A of Prior Art Gibbs '829 Patent).

Referring to FIG. 3B a curved lump is depicted with reference to three defined dimensional axis: X (east); Y (north); and Z (down). The ends of the illustrated lump are represented by a top end and a bottom end. An upward force “U” is depicted as existing in the axial direction at the top end, and a downward force “D” is depicted as existing in the axial direction at the bottom end. Because the lump is curved in the illustrated example, the top and bottom ends are not axially aligned. Therefore, the upward and downward forces (U and D) are not aligned. These forces (U and D) are thus treated for purposes of the following discussion as vectors—each possessing three dimensional directions and a magnitude. The “unit vector” for each of these forces (U and D) represents the three-dimensional (X, Y, Z) orientation of the force. The length of the depicted lump is designated by a variable S. And the weight of the illustrated lump is designated by the force W and acts vertically downward.

In addition to the forces described above, when a lump is curved, the lump will experience a force required to maintain its curvature. This force is often called the normal force (or “Normal”) and designated as the force N in FIG. 3B. In the example of FIG. 3B the curvature of the illustrated lump is assumed to track a circular arc on a plane determined by the two point vectors generally corresponding to the ends of the lump and having a center at the point labeled “center of curvature.”

Having described some of the forces that will be experienced by the lumps determined by the controller 110, a discussion of an exemplary process that may be used by the controller 110 to determine the dynamic Coulomb forces that will be experienced by the lumps individually, and the rod string as a whole, will be described. One example of such a process 350 is reflected in FIG. 3C.

As discussed above, in accordance with certain teachings of this disclosure, the Coulomb friction contributions utilized by the controller 110 are determined in consideration of two aspects.

The first aspect of this friction model is based on “static” lateral forces. These forces are primarily caused by the interaction between gravitational forces and the local inclination of the wellbore. By “gravitational”, reference is made to the combination of weight (rod mass×acceleration of gravity)—always acting vertically downward, and buoyancy (from tubing fluid)—always acting “normal” (at 90 degrees to) the exposed surface of the rods.

The second aspect of this friction model embodiment is based on “dynamic” forces, or dynamic lateral forces. Such forces will vary both in magnitude and direction on a lump by lump basis as each depicts a curved section (in three dimensions) of sucker rod within a deviated or non-vertical well as the pump system operates. Examples of such dynamic forces include the axial force U acting at one end and an axial force D acting at the other end. Both U and D are discussed above with respect to FIG. 3B.

In addition to the described U and D forces, each lump will experience a normal force. As forces U and D increase, the corresponding normal force required to maintain the curvature of the rod also increases. Using 3-dimensional projections of vectors U and D, and having information relating to the curvature of the well section in which the lump under analysis is located the normal force (Normal) can be computed using a variety of techniques within the ability of a person of ordinary skill in the applicable art.

Referring to FIG. 3C the illustrated exemplary process for automatically determining various Coulomb friction forces that will be experienced will begin at initial Step 352. In general this process can be initiated upon the initial configuration of the controller 110, on a periodic basis, or in response to the initiating and completion of an automatic configuration process 200 for the controller.

Following initiation the process 352 will move to Step 354 where the controller will determine various parameters associated with each lump in the rod string, on a lump by lump basis, based on the position of the lump within the wellbore. Such general positional information can be derived by the controller 110 based on the known position of the rod string, information relating to the relative position of each lump within the rod strong, and information relating to the deviation survey.

In Step 354, the controller 110 can utilize the wellbore deviation information (or the “wellbore deviation survey”) obtained or provided in Step 204 of the automatic configuration process to determine the location of each lump within the wellbore, whether such lump is experiencing curvature (Normal) forces (and, if so, to what extent), and positional information useful for determining the U, D and other forces experienced by the lump.

Those of ordinary skill in the art will appreciate that wellbore deviation surveys are typically comprised of a collection of “stations”. At each station, a measured depth, inclination (from vertical), and azimuth (from North) are reported. Considering two points on the survey, the controller 110 can then determine whether there is any curvature between the two points (which will induce a corresponding curvature on any lumps between such points) using one or more known methods for determining curvature. One such method is the minimum curvature method. The minimum curvature method is a known method for studying the facets of the curved trajectory of deviation surveys. This method approximates the 3-dimensional curvature between two survey points as a circular arc on a plane determined by the two survey point vectors. The radius to the center of this arc can be computed by known methods. One example of an approach for implementing the minimum curvature method is summarized in Sawaryn, S. J., and J. L. Thorogood. “A Compendium of Directional Calculations Based on the Minimum Curvature Method.” SPE Drill & Compl 20 (2005) at 24-36 (SPE Paper No. SPE-84246-PA) (hereinafter “the Prior Art Sawaryn and Thorogood Paper”.

Using the minimum curvature method, the inclination and azimuth reported at the deviation survey stations can be converted to “unit vectors in the Y (north), X (East and Z (vertical) dimensional planes referenced in connection with FIG. 3B. Such data can also be used to determine a minimum curvature between the two survey stations as described above.

Using such survey stations at or very near the endpoints of each lump, the controller 110 can thus determine the unit vectors for the upward (U) and downward (D) forces for each lump in the rod string on a lump by lump basis. Additionally such information can be used by the controller 110 to determine the Normal force (N) experienced by each lump.

In the event that survey stations are not located at or very near the endpoints of a given lump, the controller 110 can utilize interpolation processes for estimating the appropriate parameters at the endpoints of such a lump. Examples of procedures whereby the location and orientation of a point along a curved section can be interpolated-using measured points-from the deviation survey stations immediately before (above) and after (below) the interpolation point may be found in the above referenced Prior Art Sawaryn and Thorogood Paper.

It should be appreciated that the determination of the relative location of each lump within the wellbore, the extent to which such lump is experience curvature (Normal) forces, and the U and D forces experienced by each lump (in X, Y, Z vectors) is not something that the controller 110 will necessarily conduct as an isolated process, but rather one that can be implemented by the controller as needed for the determination of the various individual forces acting on the lump. In other words, while the described determination process is illustrated in FIG. 3C as a discrete Step 354, it will be understood that such determinations may be made partially (e.g., determination of U and D at a given instance without determining the normal force) or as part of some other process step described below in connection with FIG. 3C.

In the example of FIG. 3C the controller 110 implements a Coulomb friction model that, in a generalized sense, determines the Coulomb friction (C′[x,t]) at any point in the rod string (i.e., for any given lump) utilizing the polynomial function set forth as EQUATION 4 (below):

$${C}^{′} [ x , t ] = Mu [ 0 , x ] * R 0 [ x ] + Mu [ 1 , x ] * R 1 [ x ] * T [ x , t ] + Mu [ 2 , x ] * R 2 [ x ] * ( T [ x , t ] ) \hat{} 2 … + Mu [ n , x ] * Rn [ x ] * ( T [ x ] ) \hat{} n \qquad EQUATION 4$$

where:
C′ is the Coulomb drag force
C′[x,t] is the instantaneous, local Coulomb drag force at depth x and time t
Mu is a coefficient of friction (scaling factor between “normal” force and “axial drag” force)
Mu[n,x] is a local coefficient which can be dependent on the materials which are in contact in the wellbore at a specific depth (example: rod-on-tubing vs rod guide-on-tubing).

NOTE: The subscript n is intended to indicate that the coefficient of friction may change—depending upon the “order” of the tension term. However in some friction models Mu[n,x] can be simplified to Mu[x].
R0 through Rn are coefficients
Rn[x] is a coefficient which applies at depth x
T is the local tension in the rod string
T[x,t] is a local instantaneous rod string tension at depth x and time t

It should be noted for the exemplary EQUATION 4 provided above, although T varies with both depth and time (because the tension changes during the stroke), R values only change with depth (because the relationship between axial force on the rod and “normal, gravitational” force on the rod is only dependent on the wellbore geometry (the deviation survey).

The number of polynomial terms (n) used by the controller 110 can vary from embodiment to embodiment and can, in some examples be zero (o) or one (1). In certain embodiments of the present disclosure, because the Coulomb friction will be determined on a lump-by-lump basis, and because each such lump will correspond to only a small segment of the rod string a single polynomial term can be used for each lump, such that Equation 5 can be simplified to EQUATION 5 (below):

$$C [ i , t ] = Mu [ i ] * ( R 0 [ i ] + R 1 [ i ] * T [ i , t ] ) \qquad EQUATION 5$$

where:
C[i,t] is the instantaneous Coulomb drag force on lump i at time t
Mu[i] is the coefficient of friction for the rod/tubing contact type at lump i
R0[i] is the “static” lateral force at lump i
R1[i] is the “slope” (or “tension dependence ratio”) of the lateral force at lump i
T[i,t] is the local, instantaneous tension on lump I at time t

NOTE: With respect to T[i,t], in some embodiments intermediate values from the finite difference solution process provide a means of computing local rod tension (T[i,t]) using computed rod displacements and Hooke's law.

Considering EQUATION 5 and returning to FIG. 3C as part of the process for automatically determining Coulomb friction the controller will implement a Step 356 where the controller, for each lump on a lump-by-lump basis, will determine the local coefficient for rod/tubing contact, Mu[i]. Although the controller 110 may perform this operation on the lumps in a variety of different orders, for purposes of the following discussion it will be presumed that the controller will begin its determination process with the bottom lump.

In one embodiment, the controller 110 will determine the Mu[i] values for each lump using as input data obtained or determined by the controller 110 during the automatic configuration process described above in connection with FIG. 2. The precise process used by the controller for determining the local Mu values will vary depending on the manner in which the Mu data was provided in the automatic configuration process discussed above in connection with FIG. 2. For example, if the Mu values were provided on a taper by taper basis, the Mu values for the lumps will correspond to the Mu values for the taper in which the lump is located since each lump, in such embodiments, would be associated with only one taper. Alternatively, if the Mu values were provided in the form of a table reflecting Mu v location on the rod string, the controller can determine the local Mu for each lump based on the lump's position within the rod string.

Regardless of the means in which Mu is expressed or provided, the controller will determine a local Mu value (Mu[i]) for each of the i lumps in the rod string at Step 356.

In addition to determining the local Mu values for each lump, the controller 110 will also determine the axial and lateral net gravitational forces for each lump at Step 358. Performance of this step will require the controller to have determined the approximate inclination and azimuth angles associated with the lump under analysis. As described above, this determination can be made by the controller 110 using the known position of the lump for which the analysis is performed, and the provided well deviation survey information. Further, as described above such positional information concerning the lump under analysis can be determined in an independent step (e.g., Step 354) or as part of Step 358.

Various approaches can be used by the controller in Step 358. For example, since each lump can be assigned a measured depth to top and measured depth to bottom, lumps can be related to the deviation survey to determine approximate inclination an azimuth angles. This process can be performed in a number of ways. One example embodiment uses measured depth weighting to derive an “average” inclination and/or azimuth using the locations and angle values for deviation surveys above, within, and below the measured depth range of the lump.

Regardless of the manner in which the positional information for each lump is determined, in the illustrated example, the controller will assign a net gravitational axial and normal force using values obtained or determined in the automatic configuration process 200, described above. In such an embodiment, the net gravitational force (combined effect of weight and buoyancy) can be calculated using EQUATIONS 6 and 7 below:

$$F [ g , axial ] = DeltaX * cos ( Inclination ) * ( Ws - 0.2234 * Ap * Rhof ) \qquad EQUATION 6$$

$$F [ g , normal ] = DeltaX * sin ( Inclination ) * ( Ws - 0.2234 * Ap * Rhof ) \qquad EQUATION 7$$

### Where:

F[g, axial] is the net gravitational force in the axial direction [expressed in lbf];
F[g,normal] is the net gravitational force in the lateral (“normal”) direction [expressed in lbf];
DeltaX is the length of the lump [expressed in ft];
Inclination is the average inclination for the lump [expressed in degrees or radians];
Ws is the specific weight of the rod string included within the lump [expressed in lbf/ft];
0.2234 is the gravitational constant Gc divided by 144 [expressed in (feet\hat{ }2/sec\hat{ }2−inch\hat{ }2)];
Ap is the pseudo area of the rod string included within the lump [expressed in inch\hat{ }2];
Rhof is the density of the tubing fluid at the depth were the lump is located [expressed in lbm/ft\hat{ }3].

The pseudo area used in EQUATIONS 6 and 7 is an area which is slightly larger than the body of the rods. This pseudo area accounts for the true geometry of the rods so that the amount of displaced fluid can be properly applied as buoyancy. Specifically, the rods include upsets and couplings—which are larger than the rod body.

An example of how the pseudo area might be calculated for a steel rod is provided in EQUATION 8 below:

$$Ap [ inch \hat{} 2 ] = Ws [ lbf / ft ] * 490 [ lbf / ft \hat{} 3 ] * 144 [ inch \hat{} 2 / ft \hat{} 2 ] \qquad EQUATION 8$$

where 490 [lbf/ft\hat{ }3] is a nominal value for “weight density” of steel.

Those familiar with the art understand that the above equation should be augmented for “composite” sucker rods (such as fiberglass sucker rods). Additionally, the volume of installed rod guides should be included in pseudo-area to account for buoyancy contributed by rod guides.

Having determined the net gravitational forces acting on each lump in Step 358, the controller 110 can then proceed to Step 360 where the static loads for each lump are determined.

A variety of different processes can be used by the controller 110 to determine the lump static loads. One exemplary process that may be used in Step 360 is depicted in FIG. 3D where an exemplary process for determining static loads is illustrated.

Referring to FIG. 3D the process 360 begins at Step 361 where the controller 110 specifies the rod direction movement and a load at the pump.

After selecting the rod direction and pump load in Step 361, the controller can proceed to Step 362 where it will first consider the static forces associated with the bottom lump. To assess the forces acting on such lump, the exemplary controller under discussion 110 will first determine the net gravitational force acting on the lump Fg under analysis (which in the first instance will be the bottom lump). In the illustrated example, Fg is determined using lump weight, inclination, and buoyancy in accordance with EQUATION 9 below:

$$Fg = Ws * DeltaX * Cos ( inclination ) - Fbuoyant \qquad EQUATION 9$$

where:
Ws is the specific weight of the rod string included within the lump [expressed in lbf/ft];
DeltaX is the lump length [expressed in lbf/ft];
Inclination is the angle of inclination for the lump-aggregated from associated deviation survey points determined as described above; and
Fbuoyant is the buoyant force exerted by any change in rod diameter at the bottom of the lump.

Various known methods may be used to compute Fbuoyant. The controller may determine Fbuoyant in a separate step, identified as Step 364 in FIG. 3D. In some embodiments, the bottom lump, Fbuoyant might be set to the area of the bottom lump times the pressure at the bottom lump. It will be appreciated that for purposes of analysis the buoyant forces need not be applied as “point forces” acting at the taper shoulders but can rather be considered as non-point forces acting on each lump.

In anticipation of the determination of Fup for the lump at issue in Step 367, the controller 110 may then calculate Pdf (the magnitude of the projection of the downward force onto the normal vector) and Puf (the magnitude of the projection of the upward force onto the normal vector) in Steps 365 and 366. These parameters may be calculated using known methods.

With the information and parameters determined as provided the controller can then proceed to Step 367 where the axial force on the top of the lump under analysis Fup is determined using EQUATION 10 (below):

$$Fup = ( ( Fdown * ( 1 + ( Mu * alpha * Pdf ) ) + ( alpha * Fc ) + Fg ) / ( 1 + ( Mu * alpha * Puf ) ) \qquad EQUATION 10$$

where:
Fup=axial force on the top of the lump
Fdown=axial force on the bottom lump
Alpha=+1 for upstroke and −1 for downstroke
Mu is the local coefficient of friction for the lump
fc is the magnitude of the Coulomb friction force (equivalent to Mu*Fnormal) where Fnormal is the net normal force acting on the lump)
Fg is the net gravitational force on the lump
Pdf is the magnitude of the projection of the downward force onto the normal vector
Puf is the magnitude of the projection of the upward force onto the normal vector

In one embodiment for purposes of calculating Fup, with respect to the first analyzed lump (the bottom lump) lump, Fdown is set to the specified load at the pump. For successive lumps (moving up the rod string toward the top), Fdown is taken as the Fup from the previous lump.

It will be appreciated that EQUATION 10 is not the only equation that could be used for the determination of the lump axial forces and similar or other formulations could be used. Further, it should be understood that EQUATION 10 is appropriate when the downward force has greater inclination than the upward force. If the reverse is true, then the force balance must consider that the tension-dependent normal force acts in opposition to the tension-independent normal force.

Once Fup is determined at the lump under analysis, the controller 100 in the example will store the record of axial and normal forces vs depth may be maintained in a table within software memory or on non-volatile storage at Step 368 and then determine at Step 369 whether there are additional lumps above the lump under analysis that require assessment.

If it is determined at Step 369 that the last computation of Fup was not performed at the top lump (i.e., the lump for which there would be no lumps above), then Fdown (the lump to be analyzed) is set to Fup (the next lump above the analyzed lump) and the mass balance is performed again on the next highest lump. If the top of rod string has been reached then Fup is stored by the controller and used as the modeled stated static conditions for the rod string in Step 370.

Once the static friction conditions have been determined by the controller 110 in accordance with a process like the one reflected in FIG. 3D, the controller can then proceed from Step 360 (referring again to FIG. 3C) to Step 372.

In the illustrated example Step 372 reflects a process step in which the controller 100 will operate the pumping system and acquire data from such operation to, among other things: (a) verify previously modeled, provided or determined configuration factors values using captured field data and (b) inform the controller's process of estimating various configuration factors including, but not limited to friction factors, such as viscous damping factors, turbulence factors, Coulomb coefficients of friction, etc.). To obtain such field data, the controller 110 can (independently or at the instigation of a user engage in operation of the pumping system to perform a variety of tests including for example, a traveling valve check test and a standing valve check tests to obtain the “fully leaked off traveling valve test force” (FLOTvcF), and “standing valve test force” (SvcF).

FIGS. 4A-4C illustrate an exemplary process 800 for estimating friction, damping, and turbulence factors for use by the controller 110 for purposes of control and diagnosis of a sucker rod pumping system in the field (sometimes referred to as “the diagnostic solution.”) Referring first to FIG. 4A, the process begins with values of fully leaked off traveling

valve test load (FloTvcF) from a traveling valve test and stabilized load SvcF from a standing valve test performed on the subject well at Step 802.

In a standing valve check test, the pumping unit is suddenly stopped at a point about 75% or more into the downstroke. It is assumed that at this point in the stroke, all sections of the rod string are moving downward. Forces are allowed to stabilize for a few seconds (e.g., 30 seconds) and the stabilized polished rod tension force is noted as the standing valve check force (SvcF). Those familiar with the art understand that (if the standing valve is not leaking) this force represents the summation of other forces:

$$SvcF = Weight of rods - buoyant forces - stuffing box friction - pump friction - combined Coulomb friction during downstroke \qquad EQUATION 11$$

In a traveling valve check test, the pumping unit is suddenly stopped at a point about 75% or more into the upstroke. It is assumed that at this point in the stroke, all sections of the rod string are moving upward. If forces from the traveling valve test are allowed to stabilize for a few seconds (e.g., 30 seconds) the stabilized polished rod tension force can be noted as the fully leaked off traveling valve check force (FloTvcF). Those familiar with the art understand that this force represents the summation of other forces:

$$FloTvcF = Weight of rods - buoyant forces + stuffing box friction + pump friction + combined Coulomb friction during upstroke \qquad EQUATION 12$$

Subtracting Equation 11 from Equation 12 yields:

$$FloTvcF - SvcF - ( 2 * ( stuffing box friction + pump friction ) = combined Coulomb friction during upstroke + combined Coulomb friction during downstroke \qquad EQUATION 13$$

Following Step 802 the controller 110 may move to an optional Step 804 where an arbitrary initial estimate may be made for the Coulomb friction factors (Mu). The exact method for deriving these estimates will depend upon the way in which Mu's are described in the particular model. For example, if Mu's are expressed for each taper, then the initial estimates can be made for each taper and those estimated values can be used by all lumps comprising that taper. If a “base Mu” and local “modifiers” are used to describe Mu's along the rod string, then the modifiers can be established (based on other criterial) and a base Mu is only needed to start the process. If the model expresses Mu as a function of depth, then some initial estimate of scaling factor can be established and the scaling factor can be applied to each “vs depth” value. In at least one embodiment the Mu values will be those calculated in accordance with the process 300 described above.

The controller 110 may then move to a Step 807 where a calculation process similar to the process depicted in FIG. 3D is performed to derive the fully leaked off traveling valve is estimated (FLoTvcFest) and the stabilized standing valve load is estimated (SvcFest) based on the various configuration factors determined by the controller 110 up to that point. Note that this calculation can be performed prior to any field operation of the pumping system and could, to reduce computational load, be performed by a computing system other than the controller. Note further that this calculation will, in various embodiments, be performed twice: once (with direction specified as “down” and pump load specified as zero) to obtain SvcFest and a second time (with direction specified as “up” and pump load specified as zero) to obtain FloTvcFest

Once the calculated (or estimated) values for FLOTvcFest, SvcFest are determined in Step 807, the controller can then compare the calculated values to the values derived from the field test (FLOTvcF, SvcF) determined in Step 802. The differences can then be used to determine a total error reflecting the magnitude of the difference between the calculated/estimated values made by the controller using the determined configuration factors and the values for FLOTvcFest, SvcFest determined through field operations. In at least one embodiment, the total error is computed as the sum of the absolute values of the differences between the two pairs of loads, or

$$Total error = \vert FLoTvcFest - FLoTvcF \vert + \vert SvcFest - SvcF \vert \qquad EQUATION 14$$

In such or other embodiments, the traveling valve or standing valve errors might be “weighted” to reflect their relative importance to the friction estimation process.

The magnitude of the Total Error can then be compared by the controller 110 to a predetermined desired minimum error at Step 808. If the Total Error is below the minimum desired error, then the controller 110 can proceed to a further calculation Step 813 where various dynamic configuration factors can be determined based on field operation of the pumping system.

If the magnitude of the Total Error is greater than the desired minimum, then the controller can proceed to a Step 810 where the Mu estimates are automatically modified by the controller to reduce the Total Error. The Mu estimates may be modified using any of a number of methods known to those skilled in the art. For example, the gradient descent algorithm could be applied. Once the Mu estimates are modified at Step 810, the controller will return to Step 807 and the described process steps will continue to repeat until an acceptable Total Error value is determined to have been achieved at Step 808.

When an acceptable Total Error between the estimated and observed traveling valve and standing valve tests has been achieved, the controller will then proceed through a series of steps in which the viscous damping factor c′ and the turbulence factor z used for control and diagnostic purposes (e.g., using EQUATION 1), In an initial step this exemplary process, Step 813, the controller 110 will make initial calculations of pump load and pump position using EQUATION 1 wherein (i) the Mu values in the calculation will correspond to the Mu values which produced minimum error in the previous steps; (ii) the viscous damping factor “c” value is set to equal to zero; and (iii) the turbulence factor “z” is set equal to zero.

Following this step, the controller 110, operating the pumping system, will generate an exemplary surface dynamometer card in Step 816 by moving the pump through at least one complete cycle and recording the received surface load and position input signals. The exemplary surface card generated by the controller 110 in Step 816 should be a “full” card-providing the most consistent upstroke and downstroke for analysis. Those familiar with the art understand the components of a surface dynamometer card as well as the reasoning for using a “full” card for adjusting viscous damping and turbulence.

After obtaining a full surface card in Step 816, the controller can proceed to Step 818 where it will compute a downhole pump card using, in this example, EQUATION 1 based on the determined Mu values and “c′” and “z” set to zero. While different approaches can be used to convert the surface card into a calculated downhole pump card in at least some embodiments, finite difference computations can be used to derive the pump card from the surface card using known techniques.

In the following series of steps, the controller 100 can then consider the data provided by the computed downhole pump card to automatically set the viscous damping and turbulence factors for EQUATION 1. Turning first to the turbulence factor “z” it will be recalled that the turbulence factor is used in EQUATION 1 to account for the complex interactions between rod guides (and rod strings) and fluids and for variations in rod guide construction.

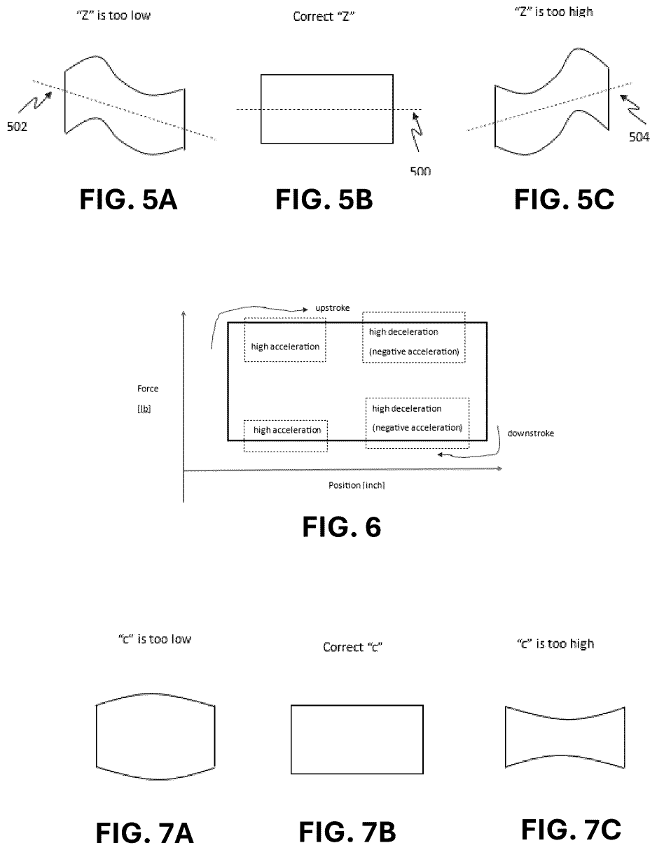

To understand the process used by the controller 110 to automatically determine the turbulence factor “z” a conceptual understanding of how that factor may impact the computed downhole pump card is helpful. Such an understanding may be obtained through consideration of FIGS. 5A-5C which reflect exemplary versions of a computed downhole pump card.

Referring To FIGS. 5A-5C, FIG. 5B illustrates an ideal downhole pump card 500 shape that is to be expected from a properly performing downhole pump. As reflected in FIG. 5B, such a card has a substantially rectangular shape with generally horizontal upper and lower segments. The inventor of this disclosure has discovered that use of the concept of a turbulence factor “z” can impact the determined downhole pump card as follow.

If the turbulence factor ‘z” is set to properly account for the turbulence experienced by the pumping system then the determined downhole pump card will have a shape that corresponds to, or is close to, the ideal pump card 500 in FIG. 5B. However, if the “z” value used for determining the downhole pump card is too high or too low, the resulting pump card will demonstrate a “wavy” shape that is “rotated”. Examples of such wavy and rotated pump cards are found in FIG. 5A ad FIG. 5C. The inventor of the present disclosure has further determined that the direction of rotation will vary depending on whether the utilized “z” value is too high or too low with the rotation occurring in the clockwise direction if z is too low and counterclockwise if z is too high.

Referring back to FIG. 4A, steps within an exemplary process that may be performed by the controller 110 to automatically determine the appropriate “z” value (Turbulence Factor) are disclosed.

Initially, the controller 110 will perform a process at Step 820 to generate a “best fit” line based on the downhole pump card generated in Step 818. In one example, this best fit line is obtained by performing a least squares linear fit of all points from the generated downhole card. Examples of “best fit” lines for the cards depicted in FIGS. 5A-5C are reflected by the dashed lines in the images. In this example, because the “c′” value is set to zero at the time of the performance of Step 820 any “rotation” of the determined cards can be considered as primarily influenced by turbulence.

NOTE: In some embodiments, the last value from the “closed” downhole card set may be excluded from the best fit calculations if the point is a duplicate of another point on the downhole card. As will be appreciated, and as reflected by the dashed lines in FIGS. 5A-5C, a “best fit” line is derived from the ideal pump card in FIG. 5B will have nearly zero slope; a “best fit” line derived from the card based on a too low “z” parameter in in FIG. 5A will have a negative slope; and a “best fit” derived from the card in FIG. 5C based on a too high “z” value will have a positive slope. As such the slope of the best fit line can be used by the controller 110 used to derive a turbulence Force “Fz” in Step 822 using EQUATION 15:

$$Fz = - 1 * m * SL \qquad EQUATION 15$$

where
Fz is the turbulence as a force [force]
m is the slope of the line fit to the pump card array [force/length]
SL is the total stroke range of the pump card [Length]

In Step 824, the controller 110 can determine whether the determined turbulence force Fz is consequential enough to merit consideration in the control of the pumping system. As will be appreciated, an inconsequential turbulence force (and minimal rotation of the downhole pump card) will have insignificant impact on the control and/or diagnosis of the system and can be ignored. As such, if the value of Fz is determined by the controller to be below a preset threshold in Step 824 then the system can move to Step 826 and set the z factors for all lumps to zero. However, if Fz is determined in Step 824 to be substantial (e.g., positive and above some minimum threshold amount) then the controller can proceed to Step 828 where the controller can assess whether the determined Fz is likely the result of turbulence or whether such Fz value potentially reflects some problem or unexpected issue with the pump system.

In Step 828 the determined value of Fz is tested against anticipated turbulence conditions. If consequential turbulence was not expected in the specific installation in which controller 110 is contained (e.g., a substantially vertical well with no rod guide), then the input data and the previously determined configuration factors should be checked at Step 830 before the process can continue. Reasons for suspecting turbulence might include-but are not limited to-wells with viscous fluids, rod guides installed, rod couplings or sinker bars with outside diameter approaching the inside diameter of the tubing.

If turbulence is suspected in Step 828, then the controller can move to Step 823 where a turbulence factor (or turbulence factors) can be calculated (832) from the determined turbulence force. The exact calculation depends upon how turbulence is included in the wave equation formulation. The turbulence term will typically involve a turbulence factor and possibly other terms applied to acceleration. If this term can be adjusted to the form of a force, that force can be equated to Fz and the maximum absolute value of acceleration derived from the pump card.

In at least one embodiment, the wave equation is re-arranged so that all terms in the wave equation are forces. In at least one embodiment, the turbulence term is expressed as:

$$Fz = z * DeltaX * acceleration \qquad EQUATION 16$$

where:
z is turbulence factor;
DeltaX is rod length; and
acceleration is the absolute value of the maximum acceleration/deceleration derived from the pump card.

In at least one embodiment, the DeltaX value used in EQUATION 16 is limited to the length of the lumps where turbulence is suspected.

Those familiar with the art will aware of processes for calculating acceleration from a card dataset. In general, that areas of maximum acceleration/deceleration in a rod pump dynamometer card will occur as those areas to areas of maximum distortion caused by rod guide turbulence. Those areas are generally identified in the exemplary downhole pump card depicted in FIG. 6.

Using the equations and factors determined previously, the controller 110 can then determine total turbulence factors for upwards and downwards movement of the rod string using the following equations:

$$Z\_up = Fz / ( DeltaX * Avg\_acceleration \_up ) and \qquad EQUATION 17$$

$$Z\_down = Fz / ( DeltaX * Avg\_acceleration \_down ) \qquad EQUATION 18$$

### Where:

Z_up is the turbulence factor to be used during upstroke;
Z_down is the turbulence factor to be used during downstroke;
Avg_acceleration_up is maximum pump acceleration during upstroke divided by 2; and
Avg acceleration down is maximum pump deceleration during upstroke divided by −2 . . . .

Once these Z factors are determined, the controller 110 can then allocate the z to all or the relevant lumps in Step 834 in a manner consistent with how Fz was converted to z. For example, if the total length of the rod string is used to convert Fz to z, then each lump is assigned the same z value. Alternatively, if only the rod tapers with rod guides are used to convert Fz to z, then the new z factor values are only allocated to lumps within the tapers where rod guides are installed.

Because the z factors have changed, the controller will need to determine a new downhole pump card using the new z factors. In the illustrated example, this is done in Step 836 using, for example, finite difference approximation system. Such a pump card will represent a system considering with Coulomb friction and turbulence, but not yet addressing viscous damping forces. To address this deficiency, the controller 110 can then proceed to implement a number of steps to implement an iterative procedure to automatically determine viscous damping factors and the viscous damping factor “c” in Equation 1.

To understand the process used by the controller 110 to automatically determine the viscous damping factor “c′” a conceptual understanding of how that factor may impact the computed downhole pump card is helpful. Such an understanding may be obtained through consideration of FIGS. 7A-7C which reflect exemplary versions of a computed downhole pump card.

Referring To FIGS. 7A-7C, FIG. 7B illustrates an ideal downhole pump card shape that is to be expected from a properly performing downhole pump. As reflected in FIG. 7B, such a card has a substantially rectangular shape with generally horizontal upper and lower segments.

If the viscous damping factor “c′” is set to properly account for viscous damping forces in the pumping system then the determined downhole pump card will have a shape that corresponds to, or is close to, the ideal pump card FIG. 7B. However, if the “c” value used for determining the downhole pump card is too high or too low, the upstroke and downstroke portions of the pump card will be distorted. For example, if a too low “c′” value is selected then the upstroke and downstroke portions of the derived pump card appear to be “convex” as reflected in FIG. 7A. Alternatively, if an erroneously high value is used for the viscous damping term “c” the upstroke and downstroke portions of the pump card appear to be “concaved” as reflected in FIG. 7C.

With this background, reference is again made to FIG. 4B where an exemplary process for automatically determining “c′” is illustrated.

From the previous discussion, it will be appreciated that necessity of setting a non-zero “c′” value (and the magnitude of such value) will correspond to the convexity/concavity of the upstroke and/or downstroke portions of the pump card. In one embodiment, the controller 110 can automatically assess the characteristics of the downhole pump cad generated in Step 836 and automatically determine an appropriate “c” value. Such a process is reflected in FIG. 4B, beginning with Step 400

As used in FIG. 4B, Step 400 reflects a sub-procedure that is used to is executed to derive values of several factors used in the exemplary process for automatically determining “c′.” Such factors include of Fus, Fds, CountUs, and CountDs. As used herein, Fus represents an upstroke stabilized force (which corresponds to the pump upstroke load) and Fds represents a downstroke stabilized force (which corresponds to the pump downstroke load). The factors CountUs and CountDs are discussed in more detail below.

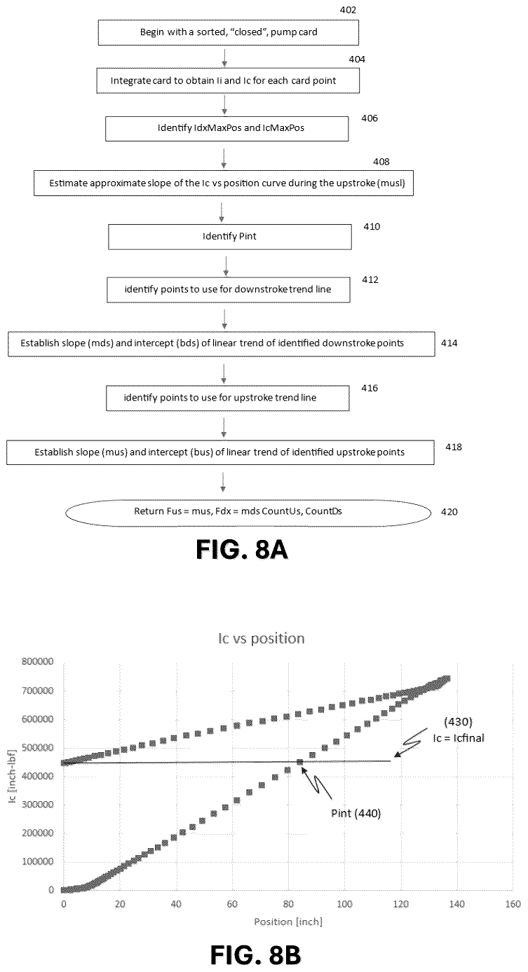

Details of an exemplary sub-procedure 400 that may be performed by the controller 110 in Step 400 are provided in FIGS. 8A and 8B. At a high level, process 400 comprises a viscous damping factor analysis that uses a subset of points from the pump card to represent the general trend of the upstroke and the downstroke. Factors such as “tagging”, “fluid acceleration”, and anomalies caused by the Coulomb friction model can cause the pump card to deviate from these general trends-particularly at the ends of the card. In the illustrated exemplary process, the raw pump card dataset is reduced to remove these anomalous points through the use of a novel filtering process which can identify the segments of upstroke and downstroke for a center-of-curvature analysis used by the controller to automatically determine “c′.”

The illustrated process begins at an optional Step 402 where the previously generated pump card dataset is re-arranged to produce an ordered set which begins with the lowest value for pump position. In the illustrated embodiment, the dataset is arranged to exhibit “clockwise” rotation starting at minimum “position” and progressing through the upstroke to maximum “position” and then back to minimum “position.” For purposes of this embodiment, it is preferred that the downhole pump card be “closed” (i.e., that the first ordered pair is same as last ordered pair. It is also preferred that the dataset be “biased” so that the minimum value for “load” is zero and the minimum value for “position” is zero. The arrangement of the pump card data to meet these specifications should be within the ability of a person of ordinary skill in the art having the benefit of this disclosure. Those familiar with the art know the methods by which the card is arranged to meet these specifications.

Step 402 is described herein as an optional step because the analytical process described hereafter can be performed without reordering or biasing the pump card data. Such ordering and biasing is addressed herein, for purposes of clarity.

In the example under discussion it is presumed that the downhole pump card used in the process is a “full” card. However, it should be appreciated that a card representing only partial fillage may be used—particularly for analyzing upstroke damping and turbulence.

In the illustrated example, following Step 402, the controller will progress to Step 404 in which the card dataset is then “integrated” to obtain incremental an integral contribution (Ii) and cumulative integral value (Ic) for each point in the card. In at least one embodiment, the trapezoidal rule is used for this integration in accordance with the following composite equation:

$$For n = 0 : \qquad EQUATION 19.1$$

$$∘ Ii [ 0 ] = 0$$

$$∘ Ic [ 0 ] = 0$$

$$For n > 0 : \qquad EQUATION 19.1$$

$$∘ Ii [ n ] = ( ( load [ n ] + load [ n - 1 ] ) / 2 ) * ( position [ n ] - position [ n - 1 ] )$$

$$∘ Ic [ n ] = I c [ n - 1 ] + i i [ n ]$$

where n is the range of values in the pump card dataset

For purposes of the following discussion, FIG. 8B depicts an exemplary plot of Ic vs pump position for an entire stroke of a representative pump card.

Following the integration process of Step 404, the controller will process the data within the dataset produced in Step 404 to identify the array index of the point where pump position is maximum (IdxMaxPos) and the associated cumulative integral at this point in the dataset (IcMaxPos). Using such a point, the controller can then define the approximate trend of the Ic vs position curve (for the upstroke) (musl) using the following equation:

$$musl = IcMaxPos / position [ IcMaxPos ] \qquad EQUATION 20$$

Once this is done, the controller can move to Step 410 in which it identifies a point (Pint). An exemplary identified Pint is reflected as item 440 in FIG. 8B. As used in this disclosure, Pint approximates the last “position” value (on the upstroke trend line) where the cumulative integral (Ic) value is less than the final value of the cumulative Integral. The final value of Ic is obtained at point n−1 using the following equation:

$$Icn - 1 = Ic value at point n - 1 = Ic [ n - 1 ] \qquad EQUATION 21$$

where n is the number of points in the card set.

The point (Pint) can then be derived using the following equation:

$$Pint = ( Icn - 1 ) / musl \qquad EQUATION 22$$

Once a Pint point has been determined by the controller 110, in the exemplary embodiment the controller will use the points for the downhole pump card and Pint to determine a downstroke trend line in Step 412 by scanning the points during the downstroke containing “position” values between Pint and ½ of Pint. The number of points found to match the filter criteria is captured as CountDs.

Using the described factors, the controller can then estimate a downstroke linear trend in Step 414 considering the points identified previously (downstroke points with position from Pint to ½ Pint). In at least one embodiment, this linear trend (slope=mds and intercept=bds) is derived using a “least squares fit” of the points identified.

Following this step, the controller 110 can move to Step 416 where it identifies the points to use for an upstroke trend line are identified by scanning the points during the upstroke containing “position” values of between ½ of Pint and Pint and capturing the number of points found to match the filter criteria as CountUs.

An upstroke linear trend is then estimated by the controller 110 in Step 418 through consideration of the points identified previously (upstroke points with position from ½ Pint to Pint). In at least one embodiment, this linear trend (slope=mus and intercept=bus) is derived using a “least squares fit” of the points identified.

Referring back to FIG. 4B, having completed the above described process 400 for determining Fus, Fds, CountUs and CountDs as just described, the controller can now proceed to Step 838 where it will begin to derive the actual values from the pump card at the middle of the upstroke (FMidUs) and downstroke (FMidDs) by interpolating the pump card during the upstroke and downstroke at points adjacent to the exact mid-point of the pump stroke. Once FmidUs and FmidDs are determined, the controller can calculate two force differences in Step 840 using the following equations:

$$FDeltaUs = FMidUs - Fus \qquad EQUATION 23$$

$$FDeltaDs = Fds - FmidUs \qquad EQUATION 24$$

These forces represent the amount of viscous friction force which is currently not accounted for by the existing values of viscous damping factors. In other words, these forces will correspond to extent of the concavity/convexity reflected in the downhole pump card.

Having determined the FDeltaUs and FDeltaDs forces, the controller can the use such information to derive initial estimates of the upstroke and downstroke damping factors (“c′”). The exact calculation used to generate such estimated factors may vary from embodiment to embodiment and will depend upon how damping is included in the wave equation formulation. For example, in some embodiments, the viscous damping factor (“c′”) will typically involve a viscous damping factor applied to speed. In other embodiments, a “dimensionless” damping factor is used, and it is made “dimensional” within the implementation. If the viscous damping term can be adjusted to the form of a force, that force can be equated to FDeltaUs and FDeltaDs-along with absolute value of acceleration derived from the pump card.

In at least one embodiment, the wave equation is re-arranged so that all terms in the wave equation are forces. In such an embodiment, the viscous damping term may be expressed as:

$$Fc = c * DeltaX * speed / 2 \qquad EQUATION 25$$

where:
c is the viscous damping factor
DeltaX is rod length
Speed is the absolute value of the maximum pump speed derived from the pump card and may be determined form a pump card data set using known techniques.

In at least one embodiment, the upstroke initial estimated damping factor (“c”) is derived by the controller 110 in Step 842 using the following equation:

$$c\_upstroke = FDeltaUs / ( DeltaX * max speed on upstroke / 2 ) \qquad EQUATION 26$$

And downstroke damping factor can be derived in Step 842 using the following equation:

$$c\_downstroke = FDeltaDs / ( DeltaX * max speed on downstroke / 2 ) \qquad EQUATION 27$$

Once the initial upstroke and downstroke viscous damping factors are determined in Step 842, an iterative calculation cycle represented by Step 843-Step 858 (in FIGS. 4B and 4C) is then used to refine viscous damping factors—until one of several exit criteria defined exit criteria are determined to be satisfied in

It should be noted that the exit criteria decisions (Step 848, 854, 858) are made independently for upstroke vs downstroke. It is typical that the process of refining upstroke damping vs downstroke damping are completed after different numbers of iterations.

Referring to FIGS. 4A, 4B, and 4C it will be understood that in the illustrated example, each iteration begins with the pre-calculation process (Step 843) followed by a finite difference execution to generate the pump card for the given values of Mu's and z's and the latest estimates of viscous damping factors (c) in Step 844. Then current value of CountUs is compared to the prior value of CountUs in Step 848. If the current value is 2 or more less than the prior value, then refinement of upstroke damping is complete.

If not, the current value of CountDs is compared to the prior value of CountDs in Step 848. If the current value is 2 or more less than the prior value, then refinement of downstroke damping is complete.

If not, and the process is to be continued, the FmidUs and/or FmidDs are derived I—as necessary—in Step 850 and FDelatUs and FDeltaDs are derived in Step 852 using EQUATIONS 23 AND 24—as necessary.

Another set of exit criteria are then applied (854). If FDeltaUs is negative then the refinement of the upstroke damping is suspended. If FDeltaDs is negative then the refinement of the downstroke damping is suspended.

Equations 26 and 27 are used—as necessary—to calculate MODIFIERS (856) for upstroke and downstroke damping factors.

The values of these modifiers are then compared to a minimum threshold value in Step 858. This threshold will depend upon how viscous damping is included in the wave equation formulation-resulting in a minimum “realistic” resolution for viscous damping. In at least one embodiment, this threshold could be 0.001.

If the modifier for upstroke damping is less than the threshold, then upstroke damping factor refinement is suspended. If the modifier for downstroke damping is less than the threshold, then downstroke damping factor refinement is suspended.

If refinement is to continue to another iteration, then the estimates of damping factors are modified in Step 862. During these iterations, Equations 26 and 26 can be used to generate modifier values for their respective damping factors-not absolute values for their respective damping factors. For example, if the existing upstroke damping factor (upon entry to the iteration) was 0.015 and during this iteration equation 8.7 produced a value of 0.003, then the new upstroke damping factor will be 0.018.

Upon completion of the process at Step 860, controller 110 automatically determined estimates for Coulomb friction factors (Mu's), Turbulence factors (z's) and viscous damping factors (c's) have been automatically derived. Referring back to FIG. 3C completion of Step 860 will correspond to the completion of Step 372.

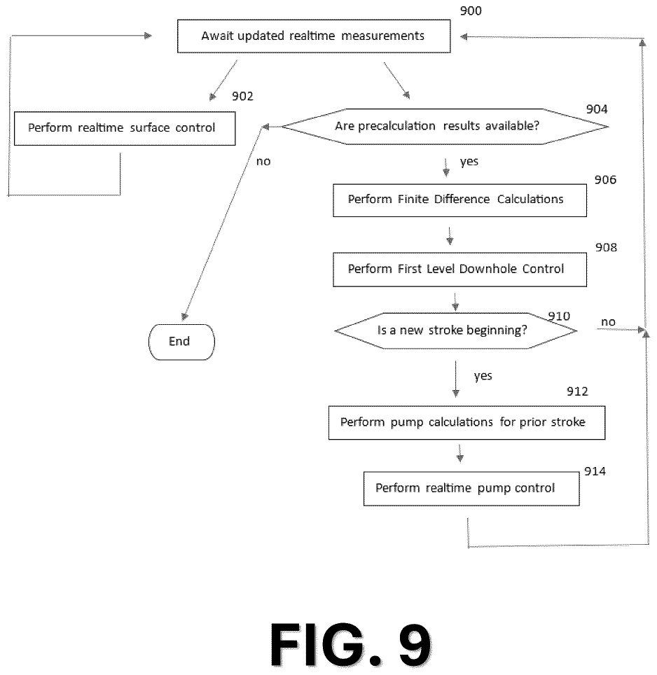

Once the system commissioning process is completed (with or without a pre-calculation process) the system controller may begin controlling the operation of the overall sucker rod system in Step 374. This control functionality may be accomplished through implementation of the control method reflected in FIG. 9 which describes real-time control process that may be implemented by a controller 110 coupled to a pumping system that is used in a deviated well.

The deviated well controller of FIG. 9 performs numerous functions. The execution of each function begins when new measurements (example: polished rod load, polished rod position, motor current, vibration) are gathered in Step 900 from sensors or from the device's input/output system. The surface control logic uses some of these measurements to make determination about the operating status of the system at Step 902. For example, if the polished rod load exceeds a maximum threshold, the system is determined to be in overload state and the motor is stopped.

The controller 110 can then determine at Step 904 whether pre-calculations are available and depending on that determination, then can perform some or all of the calculations to model downhole conditions. In at least one embodiment, these calculations involve finite difference calculations in space and time which can be performed in Step 906. However, it will be appreciated that other modeling techniques (example Finite Element), can be used. With finite difference calculations, displacement and stress values can be computed for the rod string in “near real time”. For example, when the nth pair of polished rod position and load are available to the calculation routine, the displacement at the pump can be computed for time n-i (where i is the number of rod segments or lumps).

Once the modeled conditions are determined, using at least some of those conditions (e.g., intermediate stresses and displacements), the controller can implement rudimentary “first level” control features in Step 908. For example, if the stresses on the top of a rod segment exceed the preset limit of stress for that segment, an overload condition can be detected, and the system can be stopped.

When the system has detected the completion of each stroke in Step 910 additional calculations can be made based on the entire pump stroke in Step 912. For example, the gross pump stroke and net pump stroke can be determined.

Once the full stroke determinations are completed, the controller can then implement additional control functionality in real time at Step 914. For example, if the net stroke length falls below a predetermined fraction of the gross stroke length, then “pump off” can be detected and the system can be stopped or can have its speed reduced. As another example, depending on the fluid load and pump input pressure calculated using the derived downhole card, the operation of the system can be stopped and/or the operational speed adjusted or slowed. Still further any control functionality or diagnostic functionality based on an analysis of a downhole pump card can be implemented by the controller using pump card derived using one or more of the processes described above (e.g., an assessment of gas interference v. pump off, speed adjustments to avoid fluid pound, etc.).

The process can then continue indefinitely as the controller 110 controls the pumping system in real time.

As will be appreciated from a review of the preceding disclosure, the control system described above has many advantages over conventional sucker rod pump control systems. Among other advantages, the above described controller simplifies the application of the wave equation for pump control. Further, use of the described control system allows controllers to be commissioned for use in the field without the requirement of having a trained commissioning expert tune all or some of the configuration factors described above. Still further, because of the more accurate dynagraph cards and other control data generated and provided by the described control system, operators of such systems may have a better and more accurate understanding of the operation of the systems and software packages that performs real-time (or non real-time) analysis of field data can provide more accurate and useful results that can be utilized without the need for expert or highly-trained intervention assistance.

In addition to being useful for controlling the operation of a sucker rod pumping system installed in the field, the processes described above can be used to predict the performance of a specific set of pumping equipment forming a sucker rod pumping system when later installed in the field. Such predictive use can be beneficial, for example, in selecting the appropriate equipment for use in a given application; for assessing the cost/benefit of using one component of equipment in place of another; developing optimal control strategies for one or a group of pumping systems; predictive maintenance; and/or performance estimation.

When used for predictive purposes the boundary conditions for a predictive system constructed in accordance with teachings of this disclosure will include surface location and/or motion over time and various pump forces and other limiting conditions of the equipment under analysis.

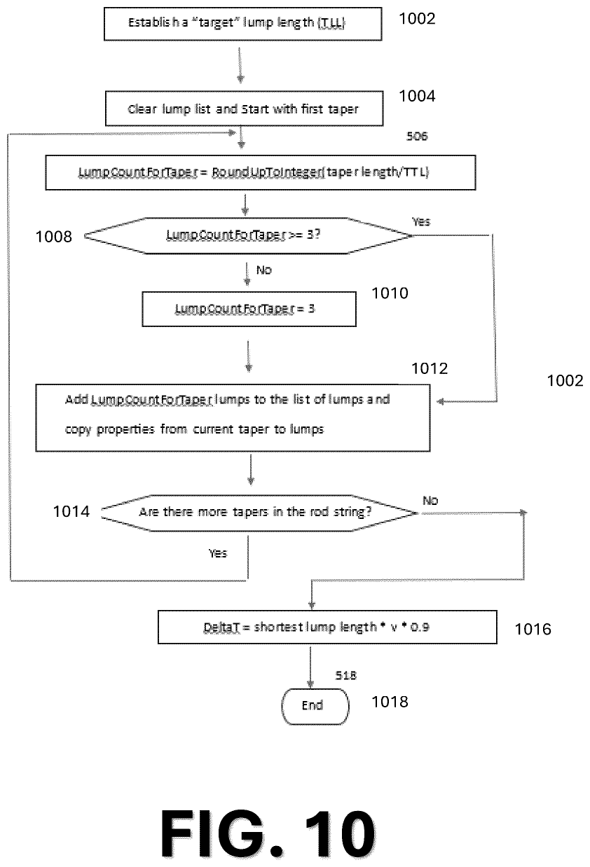

When the described processes are used for predictive purposes, some modifications of the methods described above may be warranted. For example, for predictive purposes a process other than that described above in connection with FIG. 3A may be used for dividing the tapers of the rod string into lumps. One exemplary lump division process suitable for use for predictive purposes is depicted in FIG. 10 which describes a slightly different process for dividing tapers into lumps for the predictive case. As before it should be understood that this is an exemplary process for dividing tapers into lumps, and that alternative processes can be used without departing from the teachings of this disclosure.

Referring to FIG. 10, the process for dividing the tapers to be analyzed for predictive purposes begins at Step 1002 where the controller 110 will establish a Target Lump Length (TLL). The Target Lump Length may be arbitrarily selected

Once an appropriate Target Lump Length has been determined by the computing system in Step 1002, the controller will proceed to Step 1004. It will begin the process of determining the lumps for use in the predictive analysis. In Step 1004, the computing system will clear the lump list and start with the first taper at Step 1006 where it will implement a “lump-taper boundary requirement” similar to that discussed above with respect to FIG. 3A. In accordance with this requirement, each rod “taper” must be divided into an integer number of lumps. Knowing the lengths of the tapers used in the rod string, the computing system may automatically determine lump count for each taper that would fulfill this criterial.

After implementing the lump-taper boundary requirement, the computing system can then proceed to Steps 1008 and 1010 where it will ensure that the lump count for the taper at issue is at least equal to three. Then the computing system will proceed to Step 1012 where it will update the lump count and copy the properties for the taper under analysis to the lumps assigned for that taper. Then the system will proceed to Step 1014 where it will determine whether there are any additional tapers in the rod string that need to be divided into lumps and, if so, will repeat the process described above for the next taper beginning at Step 1006.

When a determination is made in Step 1014 that all tapers have been processed, a suitable DeltaT will be determined at Step 1016 meets based to ensure that it meets the stability criterion reflected in the equation below for ΔX

$$Δ X >= V * Δ T \qquad EQUATION 28$$

where:
ΔX is lump length, which for the process of FIG. 10 will be the Target Lump Length [commonly expressed in feet];
V is the speed of sound in the rod material [commonly expressed in feet/sec]; and
ΔT is the time step used for the finite difference calculation. [commonly expressed in seconds].

For the purposes of Step 1016, ΔT can be controlled/manipulated by the subsection of the software which predicts the polished rod position at designated times and can be selected or varied by the user. In the example of FIG. 10, DeltaT is selected to be the multiple of 0.9 and the shortest lump length times v.

Those familiar with the art will appreciate that further requirements may be imposed on the “lump” selection process, for example due to limitations of a particular finite difference approximations being employed.

As will be appreciated the above describes only exemplary embodiments of a system constructed and operated in accordance with the teachings of this disclosure. Other and further embodiments utilizing one or more aspects of the inventions described above can be devised without departing from the spirit of Applicant's invention. Further, the various methods and embodiments of the methods of manufacture and assembly of the system, as well as location specifications, can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to protect fully all such modifications and improvements that come within the scope or range of equivalent of the following claims.

Further, while the above described exemplary embodiments have been described in the context of a deviated well, it will be appreciated that the teachings of this disclosure or fully applicable to non-deviated wells and/or to wells with only slight deviations.

What is claimed:

1. An adaptable controller for controlling a drive system operating a sucker rod pumping unit at different operating speeds, the sucker rod pumping unit comprising a sucker rod, the controller comprising:
a. stored processor executable instructions;
b. a programmed processor operating in response to the stored instruction;
c. a timer for determining the time of events or received inputs;
d. a first input for receiving a first input signal comprising rod position data corresponding to the surface position of the sucker rod pumping unit;
e. a second input for receiving a second input signal comprising rod load data corresponding to the surface load experienced by the sucker rod pumping unit;
f. an output for providing control signals to the drive system to cause the drive system to vary the operating speed of the sucker rod pumping unit;
g. wherein the stored instructions are configured to cause the programmed processor to:
i. sample the first input signal and the second input signal various times; and
ii. synchronize the rod position data obtained by the sampling of the first input signal and the road load data obtained by sampling the second input signal to provide data reflecting the rod position and rod load at given times; and
h. wherein the stored instructions are configured to cause the programmed processor to generate a dynamometer card in accordance with a wave equation that:
utilizes a damping coefficient c;
utilizes a rod on tubing drag force C′(x) determined by the processor that includes both a tension-independent component and a tension-dependent friction component; and
utilizes a turbulence factor z;
i. wherein the stored instructions are configured to cause the programmed processor to use the generated dynamometer card to provide a control signal to the controller output to cause the drive system to vary the operating speed of the sucker rod pumping unit.

2. The adaptable controller of claim 1 wherein the stored instructions are configured to cause the programmed processor to automatically adjust the magnitude of the turbulence factor z through performing the method steps of:
a. providing output signals to the drive system to operate the sucker rod pump over a given period of time;
b. over the given period of time, receiving input signals at the first and second inputs and determining a full dynamometer card for the sucker rod pump;
c. generating a best fit line by performing a least squares linear fit of all points from the generated downhole card;
d. determining the slope of the best fit line;
e. determining a magnitude of the turbulence force associated with the best fit line; and
f. adjusting the magnitude of the turbulence factor z upward if the magnitude of the turbulent force is above a threshold amount and the slope of the best fit line is negative; and
g. adjusting the magnitude of the turbulence factor z downward if the magnitude of the turbulent force is above a threshold amount and the slope of the best fit line is positive.

3. The adaptable controller of claim 1 wherein sucker rod pumping unit comprises a rod string and a plurality of rod guides coupled to the rod string at various locations and wherein the stored instructions are configured to cause the programmed processor to determine the turbulence factor z through performing the method steps of:
a. dividing the rod string, for purposes of analysis, into discrete segments or “lumps”;
b. determining a lump-specific turbulence factor for those lumps associated with one of the rod guides.

4. The adaptable controller of claim 1 wherein the stored instructions are configured to cause the programmed processor to determine whether the sucker rod is moving up or down at a given time and to vary the magnitude of the turbulence factor z based on whether the sucker rod is moving up or down.

5. The adaptable controller of claim 1 wherein sucker rod pumping unit comprises a rod string and a plurality of rod guides coupled to the rod string at various locations and wherein the turbulence factor z varies based on the form of the rod guides.

6. The adaptable controller of claim 1 wherein the stored instructions are configured to cause the programmed processor to automatically adjust the magnitude of the damping coefficient c through performing the method steps of:
a. providing output signals to the drive system to operate the sucker rod pump over a given period of time;
b. over the given period of time, receiving input signals at the first and second inputs and determining a full dynamometer card for the sucker rod pump;
c. based on the determined full dynamometer card;
i. determining a pump upstroke load;
ii. determining a pump downstroke load;
d. independently determining an upstroke c value and a downstroke c value based on the determined upstroke and downstroke loads.

7. The adaptable controller of claim 1 wherein the stored instructions are configured to cause the programmed processor to determine C′(x) through performing the method steps of:
a. dividing the rod string, for purposes of analysis, into discrete segments or “lumps” with each lump being associated with a location x on the rod string;
b. determining a lump-specific local Coulomb coefficient of friction forces for at least one lump in which a location coefficient of friction is determined for the location x associated with the lump and in which the local friction is determined based on the equation below:
$${C}^{′} ( x ) = δ μ ( x ) * [ Q ( x ) + T ( x ) E A \frac{d u}{d x} ]$$
where:
C′(x) is the local Coulomb friction force;
x defines a particular location along the sucker rod string associated with the lump;
$$δ = \frac{\frac{du ( x , t )}{dt}}{\vert \frac{du ( x , t )}{dt} \vert}$$
indicates rod direction at the time of calculation (up vs down);
μ(x) is a local coefficient of friction for the rod lump;
Q(x) reflects a tension-independent component of the Coulomb friction at x at time;
T(x) reflects a tension-dependent component of Coulomb friction at x at time t;
E is modulus of elasticity of the lump;
A is the cross-sectional area of the rod segment/lump; and
du/dx is evaluated at the lump, in real time.

8. An adaptable controller for controlling a drive system operating a sucker rod pumping unit at different operating speeds, the sucker rod pumping unit comprising a sucker rod, the controller comprising:
a. a programmed processor operating off of stored instruction;
b. a timer for determining the time of events or received inputs;
c. a first input for receiving a first input signal comprising rod position data corresponding to the surface position of the sucker rod pumping unit;
d. a second input for receiving a second input signal comprising rod load data corresponding to the surface load experienced by the sucker rod pumping unit;
e. an output for providing control signals to the drive system to cause the drive system to vary the operating speed of the sucker rod pumping unit;
f. wherein the stored instructions are configured to cause the programmed processor to:
i. sample the first input signal and the second input signal various times; and
ii. synchronize the rod position data obtained by the sampling of the first input signal and the road load data obtained by sampling the second input signal to provide data reflecting the rod position and rod load at given times; and
g. wherein the stored instructions are configured to cause the programmed processor to generate a dynamometer card in accordance with the equation below:
$$\frac{{d}^{2} u ( x , t )}{d {t}^{2}} = {v}^{2} \frac{{d}^{2} u ( x , t )}{d {x}^{2}} - {c}^{′} \frac{d u ( x , t )}{d t} - {C}^{′} ( x ) + g ( x ) - z \frac{{d}^{2} u ( x , t )}{d {t}^{2}} \qquad EQUATION 1$$
wherein:
“x” is the distance of a point on the sucker rod from a define point;
“t” is time;
“μ(x, t)” is the displacement of the sucker rod from a defined position at time t;
“v” is the velocity of sound in the sucker rod material;
“c′” is a damping coefficient;
“C′(x)” represents the rod on tubing drag force and includes both a tension-independent component and a tension-dependent friction component;
“g(x)” represents a rod weight component; and
“z” is a turbulence factor; and
h. wherein the storied instructions are configured to cause the programmed processor to utilize the generated dynamometer card to provide a control signal to the controller output to cause the drive system to vary the operating speed of the sucker rod pumping unit.

9. A method of operating a sucker rod pumping unit at different operating speeds, the sucker rod pumping unit comprising a sucker rod, the controller comprising:
a. determining the surface rod position at various times;
b. determining the rod load at various times;
c. time synchronizing the determined rod position data with the determined road load data to provide data reflecting the rod position and rod load at given times; and
d. generating a dynamometer card in accordance with the equation below:
$$\frac{{d}^{2} u ( x , t )}{d {t}^{2}} = {v}^{2} \frac{{d}^{2} u ( x , t )}{d {x}^{2}} - {c}^{′} \frac{d u ( x , t )}{d t} - {C}^{′} ( x ) + g ( x ) - z \frac{{d}^{2} u ( x , t )}{d {t}^{2}} \qquad EQUATION 1$$
wherein:
“x” is the distance of a point on the sucker rod from a define point;
“t” is time;
u(x, t)” is the displacement of the sucker rod from a defined position at time t;
“v” is the velocity of sound in the sucker rod material;
“c′” is a damping coefficient;
“C′(x)” represents the rod on tubing drag force and includes both a tension-independent component and a tension-dependent friction component;
“g(x)” represents a rod weight component; and
“z” is a turbulence factor; and
e. utilizing the generated dynamometer card to provide a control signal to the controller output to cause the drive system to vary the operating speed of the sucker rod pumping unit.

10. The method of claim 9 further comprising the steps of:
a. dividing the rod string for purposes of analysis, into discrete segments or “lumps;” and
b. determining the Coulomb friction experienced by each lump and an overall Coulomb friction model for the rod string where such model determines the Coulomb friction for each lump as being partially dependent upon local rod tension and partially independent of rod tension.

11. The method of claim 10 wherein the step of dividing the rod string into lumps comprises the steps of:
a. determine a minimum time differential (AT) over which the rod load and rod position will be determined during operation of the system;
b. determining a target lump length ΔX where:
$$Δ X <= V * Δ T$$
where:
i. ΔX is the target lump length;
ii. V is the speed of sound in the sucker rod material; and
iii. ΔT is the minimum time differential.

12. The method of claim 10 further comprising the step of determining static lateral forces acting on each lump based on:
a. wellbore deviation survey data reflecting the local inclination of the wellbore at various locations along the wellbore;
b. data reflecting the rod mass for the lump.

13. The method of claim 12 further comprising the step of determining dynamic lateral forces acting on each lump that vary both in magnitude and direction on a lump-by-lump basis based on the location of each lump within a deviated well.

14. The method of claim 10 wherein the rod position is determined based on received rod position data from a position sensor.

15. The method of claim 10 wherein the rod load is determined based on received rod load data from a load sensor.
